(19) United States
(12) Patent Application Publication
(10) Pub. No.: US 2014/0257856 A1
(43) Pub. Date: Sep. 11, 2014

(54) HEALTH SUPPORT SYSTEM, HEALTH SUPPORT METHOD AND NON-TRANSITORY COMPUTER READABLE RECORDING MEDIUM

(71) Applicant: KONICA MINOLTA, INC., Tokyo (JP)

(72) Inventor: Kosuke SASAI, Kobe-shi (JP)

(73) Assignee: KONICA MINOLTA, INC., Tokyo (JP)

(21) Appl. No.: 14/203,481

(22) Filed: Mar. 10, 2014

(30) Foreign Application Priority Data
Mar. 11, 2013 (JP) 2013-047433

(51) Int. Cl. G06F 19/00

(52) U.S. Cl. CPC G06F 19/322
USPC 705/3

(57) ABSTRACT

First information includes a plurality of pieces of combination information each indicating a combination of elements over a plurality of items each related to a state of a person, and a plurality of pieces of health information each associated with combination information. A numerical value is acquired for at least one numerical value item, and an element is acquired for at least one different item. Second information in which a plurality of elements indicating a plurality of ranges belong to each numerical value item is referenced, and an element indicating a range to which the acquired numerical value belongs is recognized for each numerical value item. The health information corresponding to a combination of one or more elements acquired for one or more different items and an element indicating one or more ranges recognized for one or more numerical value items is detected from the first information and visually output.

This application is based on application No. 2013-047433 filed in Japan, the contents of which are hereby incorporated by reference.

### BACKGROUND OF THE INVENTION

1. Field of the Invention

The present invention relates to a health support system, a health support method, and a non-transitory computer readable recording medium.

2. Description of the Background Art

In recent years, management of medical information by electronic medical chart, and the like is being carried forward at the medical front. A system for providing information such as state, handling method, and the like of injuries and diseases corresponding to the state of the patient serving as the user of the medical institution has been proposed (see e.g., Japanese Patent Application Laid-Open No. 2006-42986 and Japanese Patent Application Laid-Open No. 2008-102699).

For example, in the technique of Japanese Patent Application Laid-Open No. 2006-42986, a value of a user related to a determination element for determining injury/disease is acquired from result data related to examinations and medical interviews, a determination flag row of the user is generated, and the determination flag row and a determination condition factor are compared in the priority order of the determination condition factor. The comparison is stopped when the determination flag row and the determination condition factor match, and a sentence associated with the matching determination condition factor is output as a determination result.

In the technique of Japanese Patent Application Laid-Open No. 2008-102699, one name of a disease combined with all of one or more symptom elements recognized in response to the information input related to the medical interview and the like by the user is detected, and a plurality of handling names are detected from the one name of the disease. The disease handling information in which one name of the disease and the plurality of handling names are combined is visually output.

In the technique of Japanese Patent Application Laid-Open No. 2006-42986, however, the comparison is stopped when the determination flag row and the determination condition factor match, and hence the information on the determination result related the determination condition factor, which priority order is relatively toward the back, is not obtained.

Furthermore, in the technique of Japanese Patent Application Laid-Open No. 2008-102699, the name of the disease and the handling names are detected only from the combination of symptoms selected by the user from the options prepared in advance, and thus the health information related to the name of the disease, the handling name, and the like that corresponds with a wide range of situations related to the user cannot be obtained.

### SUMMARY OF THE INVENTION

The present invention addresses the health support system.

According to the present invention, a health support system includes a storage unit configured to store first reference information, the first reference information being information in which a plurality of pieces of combination information is accumulated and in which health information is associated with respect to each of the pieces of combination information, each of the pieces of combination information being information indicating a combination of two or more elements over two or more items of a plurality of items related to a state of a person, one or more elements belonging to each item of the plurality of items in each of the pieces of combination information; an acquiring portion configured to acquire a numerical value related to a state of one user for each item of one or more numerical value items of the plurality of items, and acquire an element related to the one user for each item of one or more different items different from the one or more numerical value items of the plurality of items; a range recognizing portion configured to recognize an element indicating a range to which the numerical value acquired by the acquiring portion belongs for each item of the one or more numerical value items by referencing second reference information in which a plurality of elements indicating a plurality of ranges belong to each item of the one or more numerical value items; a detecting portion configured to detect the health information corresponding to a combination of one or more elements acquired for the one or more different items by the acquiring portion and one or more elements indicating one or more ranges recognized for the one or more numerical value items by the range recognizing portion by referencing the first reference information; and an output unit configured to visually output the health information detected by the detecting portion.

The health information that corresponds with the detailed situation of the user thus can be presented.

The present invention also proposes a health support method.

Furthermore, the present invention proposes a non-transitory computer readable recording medium.

It is thus an object of the present invention to provide a health support technique capable of presenting the health information that corresponds with the detailed situation of the user.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram illustrating a schematic configuration of a health support system according to one preferred embodiment;

FIG. 2 is a diagram illustrating a functional configuration example of a data center server;

FIG. 3 is a diagram illustrating a functional configuration example of a hospital server, terminal devices, and a management device;

FIG. 4 is a diagram illustrating a functional configuration example related to a health support function of the health support system;

FIGS. 5 to 10 are diagrams illustrating a data content of a knowledge base;

FIG. 11 is a view illustrating a top screen displayed in a health support operation;

FIG. 12 is a view illustrating a search screen displayed in the health support operation;

FIG. 13 is a view illustrating a medical interview screen displayed in the health support operation;

FIG. 14 is a view illustrating a data input screen displayed in the health support operation;

FIG. 15 is a view illustrating an advice presenting screen displayed in the health support operation;

FIG. 16 is a view illustrating a data inquiry screen displayed in the health support operation;

FIG. 17 is a view illustrating a notice screen displayed in the health support operation; and

FIGS. 18 to 25 are flowcharts illustrating a process flow in the health support operation.

### DESCRIPTION OF THE PREFERRED EMBODIMENT

One preferred embodiment of the present invention will be hereinafter described based on the drawings. In the drawings, the same reference numerals denote portions having similar configuration and function, and the redundant description will be omitted in the following description.

### (1) One Preferred Embodiment

### (1-1) Schematic Configuration of Health Support System

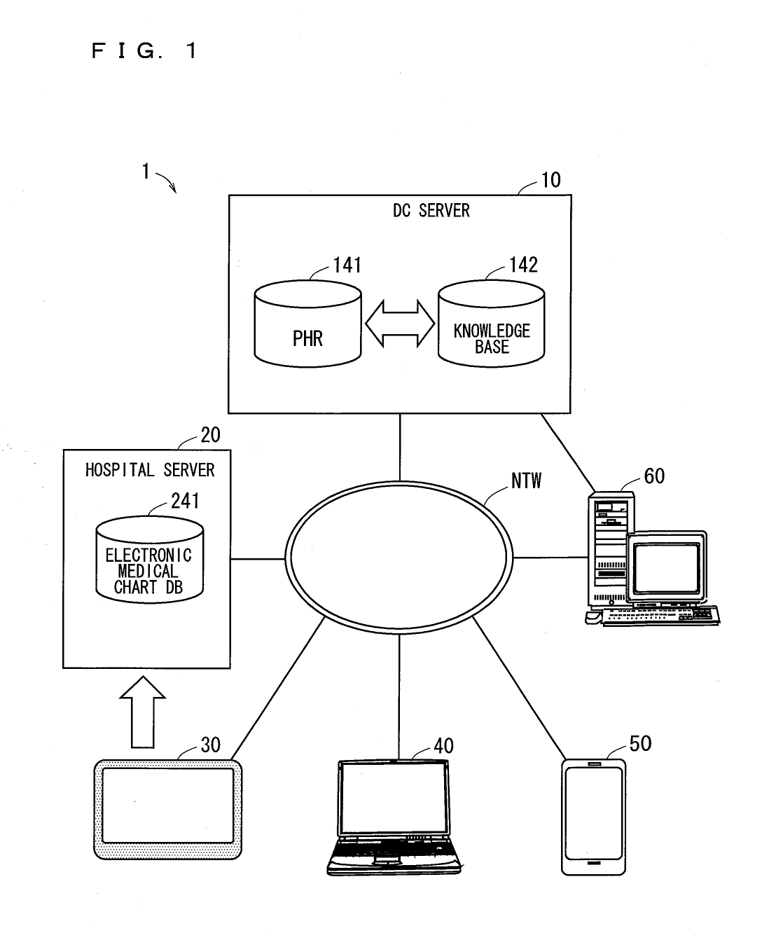

FIG. 1 is a diagram illustrating a schematic configuration of a health support system 1 according to one preferred embodiment. The health support system 1 has a function (also referred to as health support function) of providing various types of information (also referred to as health information) for supporting the health corresponding to the state of the user.

As shown in FIG. 1; the health support system 1 includes a data center server (also referred to as DC server) 10, a hospital server 20, terminal devices 30 to 50, and a management device 60. In the health support system 1, the DC server 10, the hospital server 20, the terminal devices 30 to 50, and the management device 60 are, for example, connected to be able to transmit and receive data with each other through a communication line NTW. The communication line NTW may be a wired line or a wireless line. Specifically, the communication line NTW may include, for example, a network line such as Internet line, and the like.

The DC server 10 is a server for providing the various types of information for supporting health. The DC server 10 is to be installed, for example, by an organization, or the like that manages and operates the health support system 1. The DC server 10 may be, for example, a server that provides an ASP (Application Service Provider) service. The DC server 10 includes a personal health record (PHR) 141 and a knowledge base 142.

The PHR 141 stores information indicating a state related to the health, and the like of each user of the health support system 1. The PHR 141 is built by acquiring the information of at least a part of the information of the electronic medical chart (also referred to as electronic medical chart information) for each user of the health support system 1 from an electronic medical chart database (also referred to as electronic medical chart DB) 241 of the hospital server 20, for example. The knowledge base 142 stores various types of information for detecting the health information corresponding to the state of each user stored in the PHR 141. The health information may include, for example, various types of information associated with the health of a person such as the health state, an advice for the user, and the like, which can be determined based on the medical knowledge. The various types of information stored in the knowledge base 142 are, for example, generated according to the input from the management device 60.

In such DC server 10, the health information corresponding to the state of each user is detected according to the request from the terminal device 40, 50. The health information is, for example, transmitted to the terminal device 40, 50 through the communication line NTW, and visually output at the terminal device 40, 50.

The hospital server 20 is a server installed in a medical institution. The medical institution includes, for example, hospitals of various forms such as general hospitals, private hospitals, and the like. The hospital server 20 includes the electronic medical chart DB 241. The electronic medical chart DB 241 is stored with information indicating the results of medical interview, examination, measurement, consultation, and the like for each user, for example. The electronic medical chart information related to each user is generated by performing the necessary examinations, consultations, and the like by a doctor while referencing the result of the medical interview. The information of at least a part of the electronic medical chart information related to each user is acquired from the electronic medical chart DB 241 by the DC server 10 in compliance with the permission of the medical institution where the hospital server 20 is installed.

The terminal device 30, for example, presents a question in the medical interview, accepts the input by the user of the information indicating a reply to the relevant question, and transmits the same to the hospital server 20. The terminal device 30 may be, for example, an information processing device arranged in the medical institution, and the like. The information processing device may be a portable information processing device such as a so-called tablet terminal, and the like, or a fixed information processing device. For example, when each user visiting the medical institution makes a reply to the question of the medical interview using the terminal device 30, the information (also referred to as medical interview information) indicating the reply, and the like of the medical interview by each user is input. The medical interview information input using the terminal device 30 is, for example, transmitted to the hospital server 20 through the communication line NTW, and stored in the electronic medical chart DB 241. In this case, the medical interview information of each user is described in the electronic medical chart information for each corresponding user.

The terminal devices 40, 50 are terminal devices used by the user of the health support system 1, and the like. Such terminal device 40 and terminal device 50 may be, for example, a portable telephone such as a so-called Smartphone, and the like, or a personal computer owned by the user. The user of the health support system 1 uses either one of the terminal devices 40, 50 to access the DC server 10 through the communication line NTW, thus easily acquiring various types of health information, and the like.

The management device 60 is an information processing device for managing the DC server 10. For example, the management device 60 may be installed by the organization, or the like that manages and operates the health support system 1. The information processing device may be, for example, various types of information processing devices such as a personal computer. The administrator of the health support system 1 may use the management device 60 to update and change the storage content of the knowledge base 142.

### (1-2) Functional Configuration of Health Support System

### <(1-2-1) DC Server>

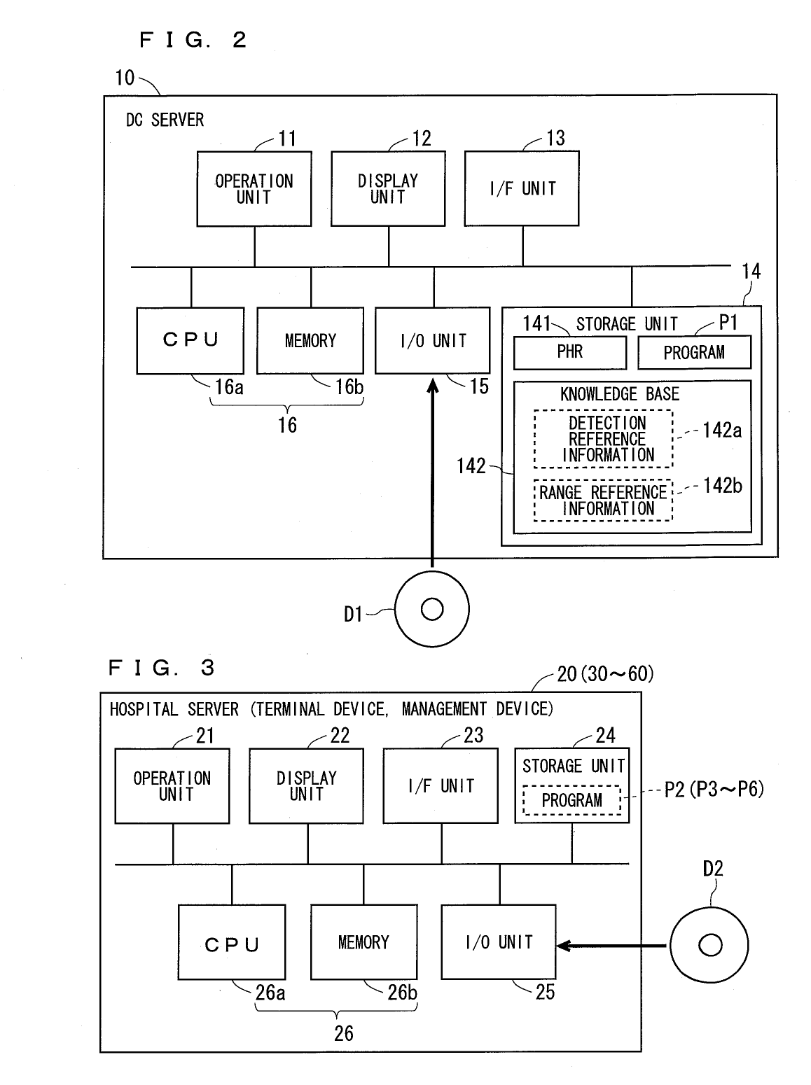

FIG. 2 is a block diagram illustrating a functional configuration of the DC server 10. The DC server 10 may be a personal computer, for example, and includes an operation unit 11, a display unit 12, an interface (I/F) unit 13, a storage unit 14, an input/output (I/O) unit 15, and a control unit 16.

The operation unit 11 includes, for example, a mouse and a keyboard. The display unit 12 includes, for example, a liquid crystal display. The I/F unit 13 exchanges data with the hospital server 20, the terminal devices 30 to 50, and the management device 60 through the communication line NTW, for example. The storage unit 14 includes a hard disk, and the like, for example, and stores a program P1, the PHR 141, the knowledge base 142, and the various types of data. The knowledge base 142 includes detection reference information 142a serving as first reference information, and range reference information 142b serving as second reference information. The I/O unit 15 includes, for example, a disk drive, and receives a storage medium D1 such as an optical disk and the like to perform data exchange between the storage medium D1 and the control unit 16. The control unit 16 includes a CPU 16a that operates as a processor, a memory 16b that temporarily stores information, and the like. The control unit 16 realizes various functions, information processing, and the like of the DC server 10 by reading and executing the program P1 stored in the storage unit 14. The various types of information temporarily obtained by the various types of information processing in the control unit 16 are stored in the memory 16b, and the like. The health support function in the health support system 1 is thus realized by executing the program P1 in the control unit 16 in such a manner.

### <(1-2-2) Hospital Server, Terminal Device, and Management Device>

FIG. 3 is a block diagram illustrating a functional configuration of the hospital server 20, the terminal devices 30 to 50, and the management device 60.

The hospital server 20 may be a personal computer, for example, and includes an operation unit 21, a display unit 22, an I/F unit 23, a storage unit 24, an I/O unit 25, and a control unit 26. The operation unit 21 includes, for example, a mouse and a keyboard. The display unit 22 is the portion (also referred to as output unit) that visually outputs various types of information, and includes, for example, a liquid crystal display, and the like. The I/F unit 23 exchanges data with the DC server 10, and the like through the communication line NTW, and the like, for example. The storage unit 24 includes a hard disk and the like, for example, and stores a program P2, the electronic medical chart DB 241, and various types of data. The I/O unit 25 includes, for example, a disk drive, and receives a storage medium D2 such as an optical disk, and the like to perform data exchange between the storage medium D2 and the control unit 26. The control unit 26 includes, for example, a CPU 26a that operates as a processor, and a memory 26b that temporarily stores information. The control unit 26 realizes various functions, information processing, and the like of the hospital server 20 by reading and executing the program P2 stored in the storage unit 24. The various types of information temporarily obtained by the various types of information processing in the control unit 26 are stored in the memory 26b, and the like.

The terminal device 30 differs from the hospital server 20 in the configuration of the operation unit 21 as well as the functions and the information processing executed by the control unit 26, for example, but has a functional configuration substantially similar to that of the hospital server 20. For example, a touch panel in which the operation unit 21 and the display unit 22 are integrated may be adopted herein. The control unit 26 realizes various functions, information processing, and the like of the terminal device 30 by reading and executing a program P3 stored in the storage unit 24.

The terminal device 40 differs from the terminal device 30 in the configuration of the operation unit 21 as well as the functions and information processing executed by the control unit 26, for example, but has a functional configuration substantially similar to that of the terminal device 30. The operation unit 21 may include, for example, a mouse and a keyboard. In the control unit 26, various functions, information processing, and the like of the terminal device 40 may be realized by reading and executing a program P4 stored in the storage unit 24.

The terminal device 50 differs from the terminal device 30 in the functions and information processing executed by the control unit 26, for example, but has a functional configuration substantially similar to that of the terminal device 40. In the control unit 26, various functions, information processing, and the like of the terminal device 50 may be realized by reading and executing a program P5 stored in the storage unit 24.

The management device 60 differs from the hospital server 20 in the functions and information processing executed by the control unit 26, for example, but has a functional configuration substantially similar to that of the hospital server 20. In the control unit 26, various functions, information processing, and the like of the management device 60 may be realized by reading and executing a program P6 stored in the storage unit 24.

### <(1-2-3) Functional Configuration Related to Health Support Function>

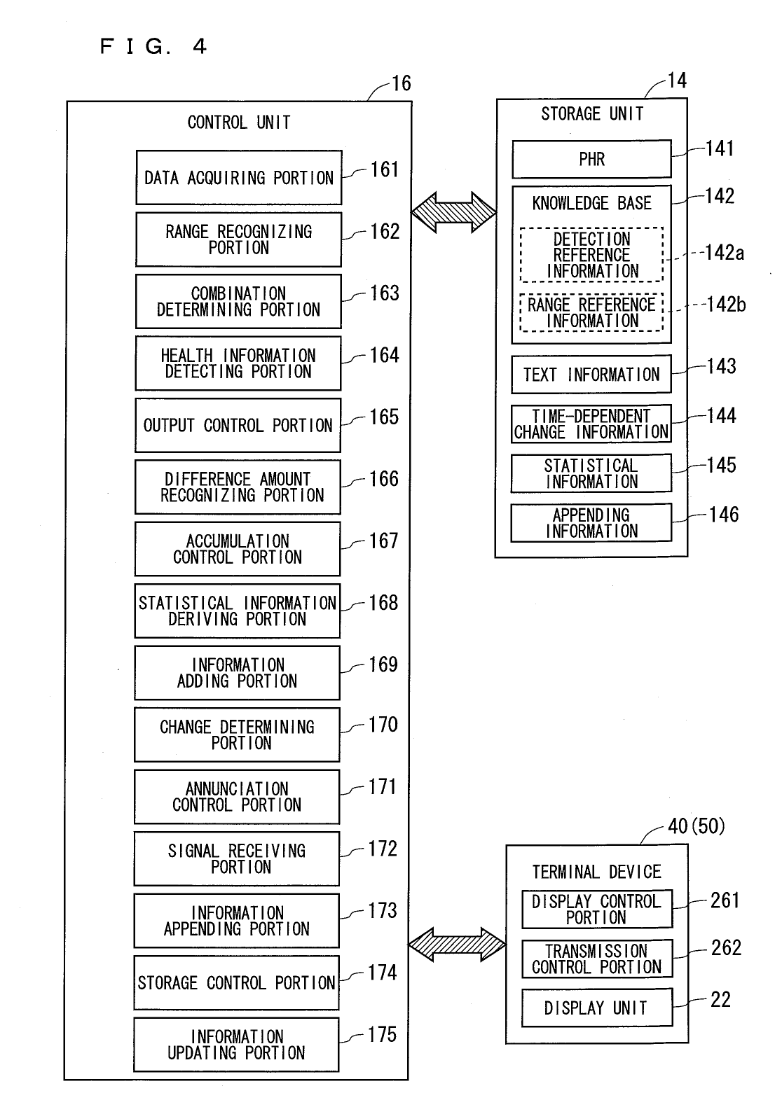

FIG. 4 is a block diagram showing a main configuration of the health support system 1. In FIG. 4, a functional configuration related to the health support function is shown.

As shown in FIG. 4, the PHR 141, the knowledge base 142, text information 143, time-dependent change information 144, statistical information 145, and appending information 146 are stored in the storage unit 14. The control unit 16 of the DC server 10 includes, for example, various types of function units as configurations realized by the execution of the program P1. The various types of function units include, a data acquiring portion 161, a range recognizing portion 162, a combination determining portion 163, a health information detecting portion 164, an output control portion 165, a difference amount recognizing portion 166, an accumulation control portion 167, a statistical information deriving portion 168, an information adding portion 169, and a change determining portion 170. The various types of function units also include an annunciation control portion 171, a signal receiving portion 172, an information appending portion 173, a storage control portion 174, and an information updating portion 175. The control unit 26 of the terminal device 40, 50 includes, for example, a display control portion 261 and a transmission control portion 262 as configurations realized by the execution of the program P4, P5.

### <(1-2-3-1) Various Types of Information Stored in Storage Unit>

The PHR 141 stores, for example, information indicating the results related to medical interview, examination, measurement, consultation, and the like for each user.

The knowledge base 142 stores the detection reference information 142a and the range reference information 142b, as described above.

The range reference information 142b is information assumed as a reference when recognizing which one of a plurality of ranges corresponds to a numerical value related to the state of the user in the range recognizing portion 162. Specifically, a plurality of elements indicating a plurality of ranges belong to each item of one or more numerical value items among a plurality of items related to the state of the person in the range reference information 142b. The one or more numerical value items may be the item related to the numerical value obtained by examination, measurement, and the like, for example.

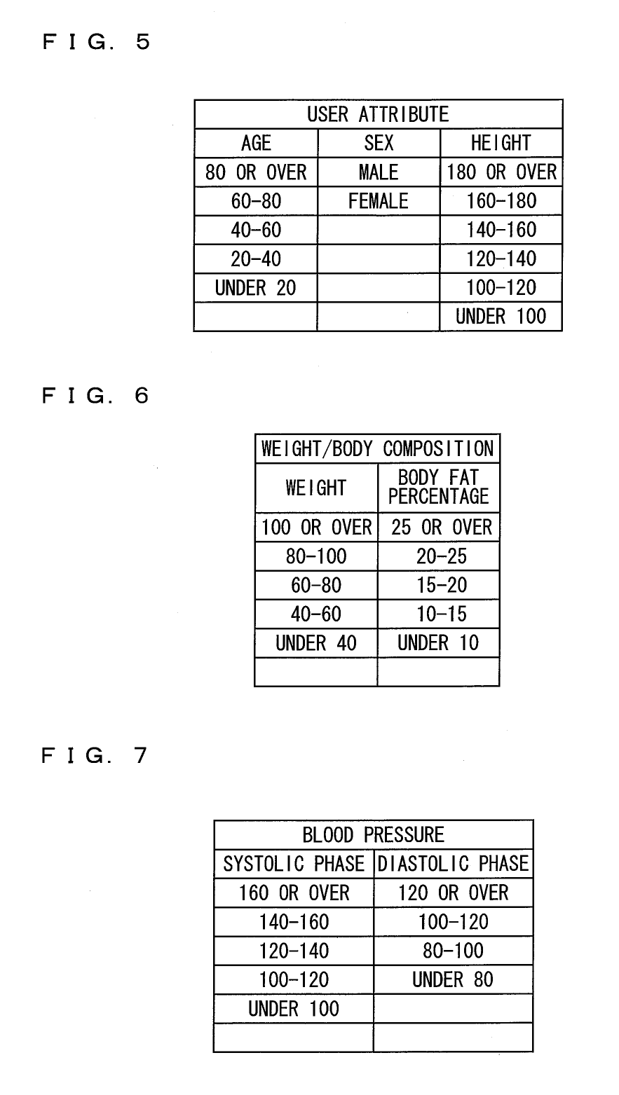

FIG. 5 to FIG. 8 are diagrams illustrating a storage content of the range reference information 142b. As shown in FIG. 5 to FIG. 8, one or more numerical value items include, for example, an item related to the user attribute such as age, height, and the like; an item related to weight and body composition such as weight, body fat percentage, and the like. The one or more numerical value items also include, for example, an item related to blood pressure such as blood pressure (hereinafter also referred to as systolic blood pressure) of systolic phase, blood pressure (hereinafter also referred to as diastolic blood pressure) of diastolic phase, and the like; an item related to blood biochemistry such as total cholesterol, HDL, neutral fat, blood glucose level, γ-GTP, and the like. For example, as shown in FIG. 5, “under 20”, “20 to 40”, “40 to 60”, “60 to 80”, and “80 or over” serving as elements indicating the plurality of ranges belong to the age serving as the numerical value item. In FIG. 5, sex is shown as an item related to the user attribute, but the sex may be included in one or more different items different from the one or more numerical value items.

The range reference information 142b may be described, for example, in the form of relational database (RDB), or may be described with XML.

The detection reference information 142a is information assumed as a reference when detecting the health information corresponding to the state of the user in the health information detecting portion 164. Specifically, in the detection reference information 142a, one or more elements belong to each item of a plurality of items related to the state of the person, and information (also referred to as element combination information) indicating a plurality of combinations, each indicating the combination of elements over two or more items among the plurality of items, are accumulated. The element combination information may include, for example, information indicating a combination of elements over some items of the plurality of items. In the detection reference information 142a, the element related to the health information is associated with respect to each piece of element combination information.

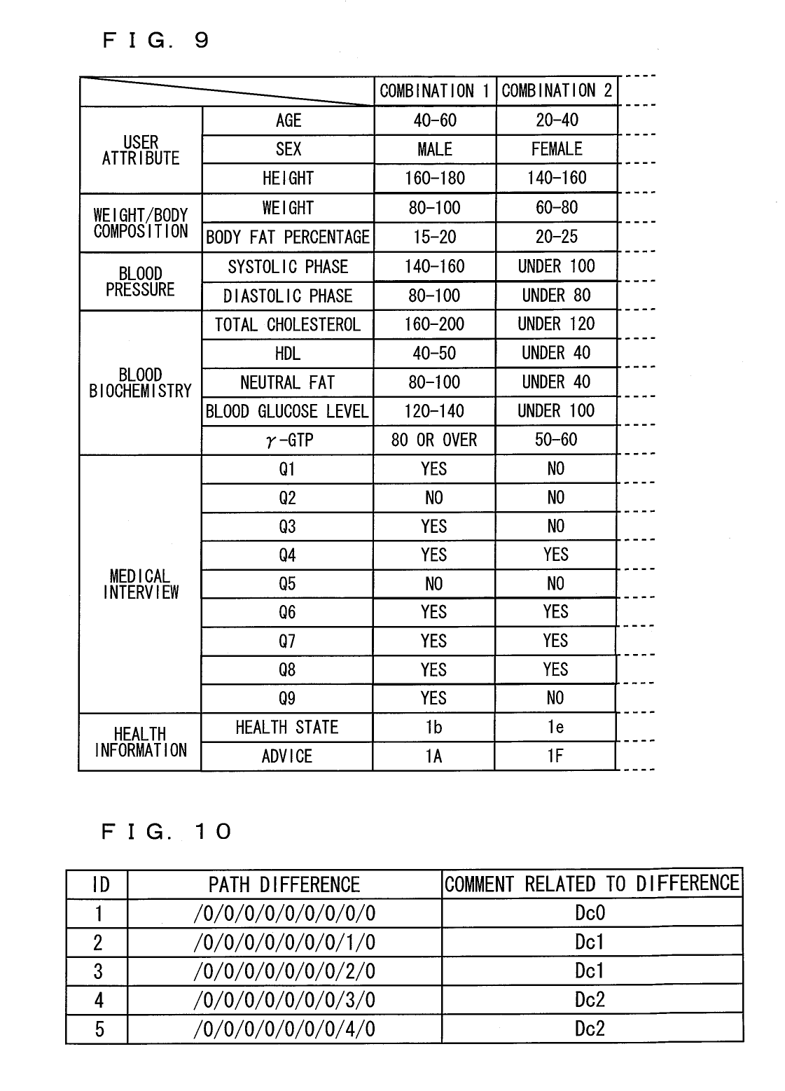

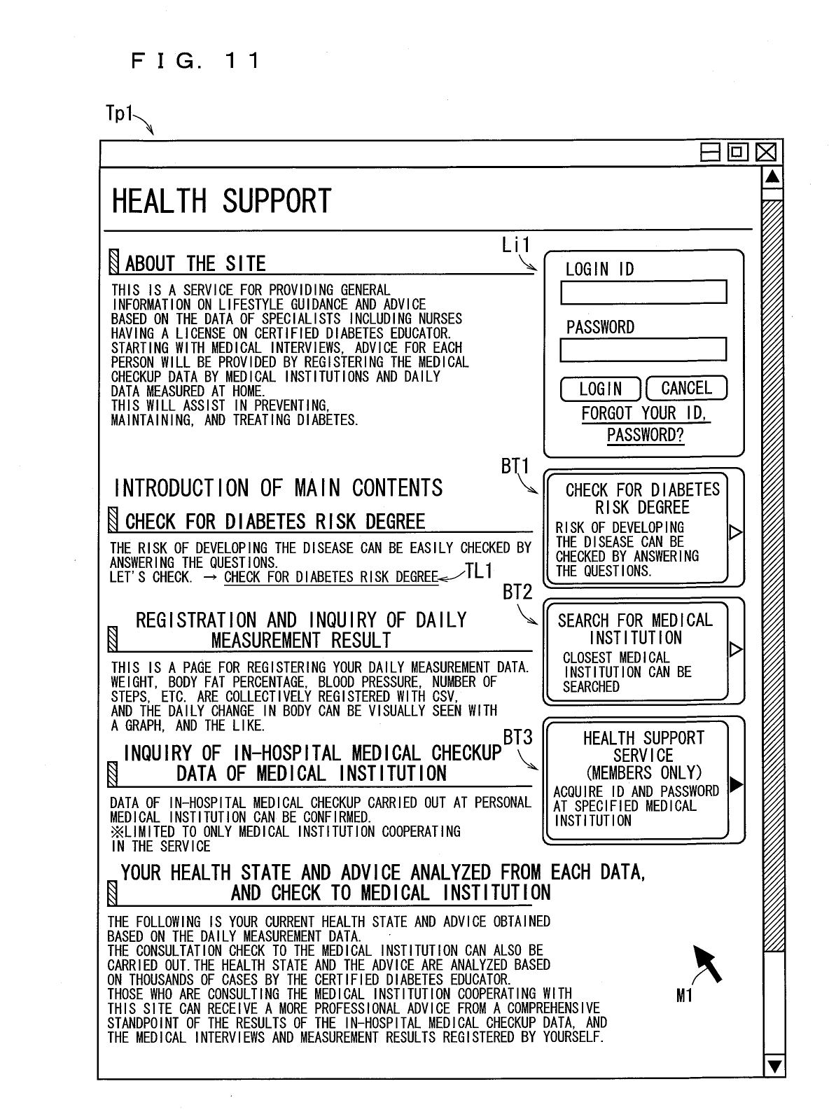

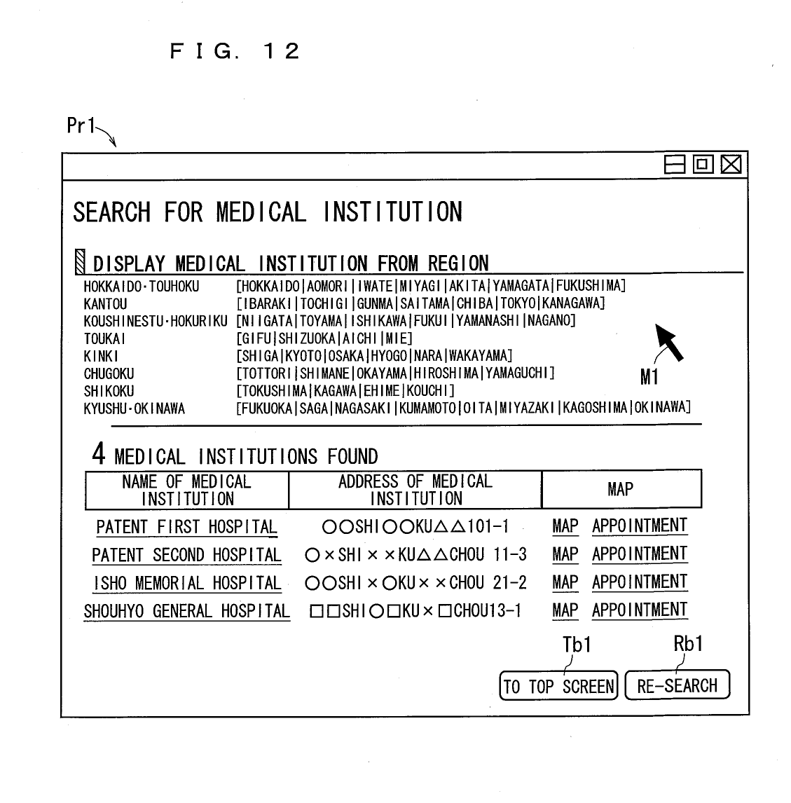

FIG. 9 is a diagram showing a storage content of the detection reference information 142a. In FIG. 9, two element combination information, combination 1 and combination 2, are shown. Each piece of element combination information indicates a combination of elements over a total of 21 items, which are three items related to user attribute, two items related to weight/body composition, two items related to blood pressure, five items related to blood biochemistry, and nine items related to medical interview. Either “male” or “female” belongs, as an element, to the sex serving as the item related to the user attribute. The nine items related to medical interview may be items related to nine questions. Either one of the replies “yes” or “no” belongs, as an element, to each of the nine items related to medical interview. The reply with respect to each item related to the medical interview is not limited to “yes” and “no”, and for example, may be one of a plurality of options such as range related to frequency, and the like.

As shown in FIG. 9, elements for two items related to the health information are associated with each piece of element combination information. The two items related to the health information include health state and advice, and the elements related to the health state and the advice belong thereto. In FIG. 9, elements 1b and 1e are shown as elements related to the health state, and elements 1A and 1F are shown as elements related to the advice. For example, the text information corresponding to each element related to the health state and the advice may be stored in the text information 143. Specifically, for example, the text information corresponding to each element 1b, 1e, 1A, 1F may be stored in the text information 143.

The detection reference information 142a, for example, may be described in the form of relational database (RDB), may be described using the XML, or may be described in the CSV format for each piece of element combination information.

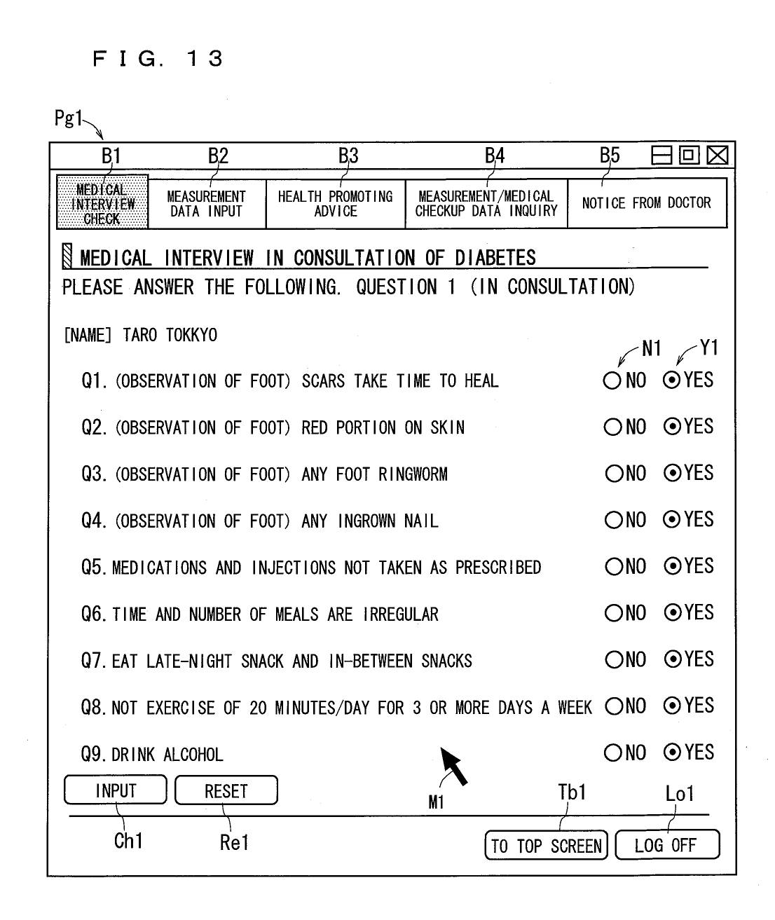

As shown in FIG. 10, the detection reference information 142a may include information in which the element related to the health information is associated with respect to each combination of difference amounts of the elements over one or more different items different from the one or more numerical value items of the plurality of items and the one or more numerical value items. In FIG. 10, the combination of difference amounts of the elements indicating range is shown as a difference of a path serving as a row of numerical values (also referred to as path difference) for the nine items related to the numerical value items including two items related to weight/body composition, two items related to blood pressure, and five items related to blood biochemistry. The difference amounts of the elements indicating range are indicated as 0, 1, 2, 3, 4, 5 serving as separation amounts of the range.

Specifically, in FIG. 10, by way of example, the path difference in which the difference amounts of the elements indicating range is 0 are shown for the items other than the item of the blood glucose level, which is the eighth item, and the path differences in which the difference amounts of the elements indicating range are respectively 0, 1, 2, 3, 4 are shown for the item of the blood glucose level. Furthermore, elements Dc0 to Dc2 are associated, as elements indicating a comment related to the difference serving as the health information, for each path difference in which the difference amounts of the elements indicating range for the item of the blood glucose level are 0, 1, 2, 3, 4. For example, the text information corresponding to each element Dc0 to Dc2 may be stored in the text information 143.

The time-dependent change information 144 is information in which the combination of elements and the combination of difference amounts of the elements corresponding to the combination of elements are associated. The time-dependent change information 144 is, for example, accumulated in the storage unit 14 by the accumulation control portion 167. The statistical information 145 is statistical information related to the combination of difference amounts of the elements for every combination of elements. The statistical information 145 is, for example, derived by the statistical information deriving portion 168. The appending information 146 is appending information appended according to the signal received by the signal receiving portion 172 with respect to the health information detected by the health information detecting portion 164. The appending information 146, for example, may be input by variously operating the operation unit 21 by a doctor assigned to the user at the hospital server 20.

<(1-2-3-2) Functional Configuration of DC server>

The data acquiring portion 161 acquires a numerical value related to the state of one user for each item of one or more numerical value items, and acquires an element related to the one user for each item of one or more different items different from the one or more numerical value items. The numerical values and the elements related to the one user, for example, may be acquired from the PHR 141 by the data acquiring portion 161. The numerical value related to the state of the one user for each numerical value item may be acquired from the information indicating the result of at least one of measurement and examination related to the state of the one user stored in the PHR 141, for example, by the data acquiring portion 161. Among the numerical values related to the state of the one user for each numerical value item, the numerical values related to age and height, which are the two items related to the user attribute, may be input by operating the terminal device 30 by the user, for example.

For each different item, the element related to the one user stored in the PHR 141 may be acquired through the electronic medical chart DB 241 according to the result of selecting one option from a plurality of options, for example, by the data acquiring portion 161. The plurality of options may be options related to the medical interview displayed on the display unit 22 of the terminal device 30, for example, and one of the plurality of options may be selected by operating the terminal device 30 by the one user.

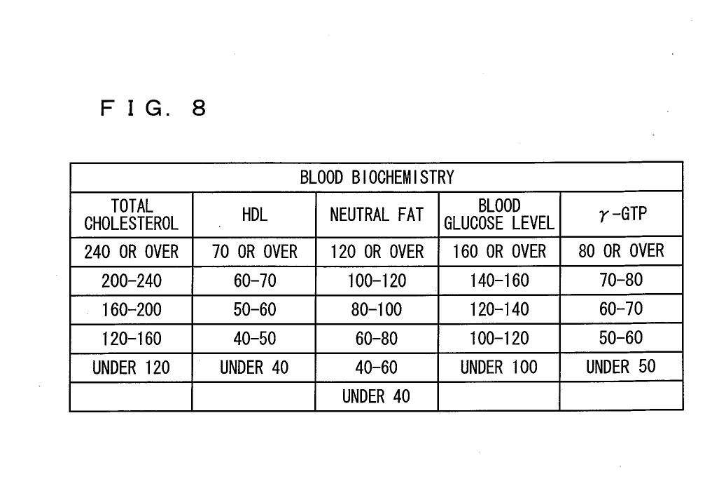

The range recognizing portion 162 recognizes the element indicating the range to which the numerical value acquired by the data acquiring portion 161 belongs for each item of one or more numerical value items by referencing the range reference information 142b. For example, in which range indicated by the range reference information 142b the numerical values acquired by the data acquiring portion 161 is included is recognized for 11 items including two items related to the user attribute, two items related to the weight/body composition, two items related to the blood pressure, and five items related to the blood biochemistry. Specifically, if the numerical value of the blood glucose level, which is the item related to the blood biochemistry, is 133 for example, 120 to 140, which is the element indicating the range to which 133 belongs is recognized from the elements indicating five ranges related to the blood glucose level shown in FIG. 8.

The combination determining portion 163 determines the combination of one or more elements acquired for one or more different items by the data acquiring portion 161, and one or more elements indicating one or more ranges recognized for one or more numerical value items by the range recognizing portion 162 as a combination of elements indicating the state of the one user. The one or more different items include, for example, sex, which is one item related to the user attribute, and nine items related to the medical interview. The one or more numerical value items include, for example, two items related to the user attribute, two items related to the weight/body composition, two items related to the blood pressure, and five items related to the blood biochemistry.

The health information detecting portion 164 detects the health information corresponding to the combination of elements indicating the state of the one user determined by the combination determining portion 163 by referencing the detection reference information 142a. For example, the element combination information including the combination of elements that matches the combination of elements indicating the state of the one user is detected from a plurality of pieces of element combination information stored in the detection reference information 142a. The element related to the health information associated with the detected element combination information is detected from the detection reference information 142a, and the text information corresponding to the elements related to the health state and the advice contained in the elements related to the health information is detected from the text information 143. The health information including the health state and the advice corresponding to the combination of elements indicating the state of the one user is thereby detected. If the plurality of pieces of element combination information stored in the detection reference information 142a includes information indicating the combination of elements over some items of the plurality of items, the health information can be detected even if the elements related to the user are not obtained for all items of examination, medical interview, and the like.

The health information detecting portion 164 detects the health information corresponding to the combination of difference amounts of the elements indicating the state of the one user recognized by the difference amount recognizing portion 166 by referencing the detection reference information 142a. The combination of difference amounts of the elements may be the combination of elements related to at least two of the plurality of items. For example, a path difference that matches the combination of difference amounts of the elements related to the one user is detected from a plurality of path differences stored in the detection reference information 142a. The element indicating a comment related to the difference serving as the health information associated with the detected path difference is detected, and the text information corresponding to the element indicating the comment related to the difference is detected from the text information 143. The health information including the comment related to the difference corresponding to the combination of difference amounts of the elements related to the one user is thereby detected.

The output control portion 165 controls the output of data to the hospital server 20, the terminal devices 30 to 50, and the management device 60 through the communication line NTW. For example, the health information detected by the health information detecting portion 164 is output to the terminal devices 40, 50 through the communication line NTW by the output control portion 165. Thus, the health information that corresponds with the detailed status of the one user can be presented in the terminal device 40, 50. Furthermore, the health information corresponding to the change in the state of the one user can be presented by the presentation of the heath information corresponding to the combination of difference amounts of the elements in the terminal devices 40, 50.

The difference amount recognizing portion 166 recognizes the difference amount of the element between a first time point and a second time point with regards to at least two items of the one pr more different items and the one or more numerical value items. The second time point may be a time point later than the first time point. The difference amount of the elements related to each different item may be the difference amount of the element related to the first time point and the element related to the second time point acquired for each different item by the data acquiring portion 161. The difference amount of the elements related to each numerical value item may be the difference amount of the element indicating the range related to the first time point and the element indicating the range related to the second time point recognized for each numerical value item by the range recognizing portion 162.

For example, the difference amount of the element indicating the range at the first time point and the element indicating the range at the second time point stored in the PHR 141 is recognized in the form of a whole number of −5 to 5 serving as a separation amount of the ranges. Specifically, for example, if the range at the first time point is 160 or over for the blood glucose level, which is the numerical value item related to the one user, when the range at the second time point is 140 to 160, the range becomes a range one below, and the difference amount of the elements is recognized as −1. When the range at the second time point is 120 to 140, the range becomes a range two below, and the difference amount of the elements is recognized as −2. On the contrary, if the range at the first time point is under 100, when the range at the second time point is 100 to 120, the range becomes a range one above and the difference amount of the element is recognized as +1. When the range at the second time point is 120 to 140, the range becomes a range two above, and the difference amount of the elements is recognized as +2.

The accumulation control portion 167 associates the combination of one or more elements acquired for one or more different items by the data acquiring portion 161 and the one or more elements indicating one or more ranges recognized for the one or more numerical value items by the range recognizing portion 162 and the combination of difference amounts of the elements related to the relevant combination. The time-dependent change information 144 is thereby generated. That is, the time-dependent change information 144 is information indicating the time-dependent change related to the one or more elements acquired for one or more different items by the data acquiring portion 161 and the one or more elements indicating the one or more ranges recognized for one or more numerical value items by the range recognizing portion 162. The time-dependent change information 144 is stored in the storage unit 14 by the accumulation control portion 167. The difference amount of the elements may be that recognized by the difference amount recognizing portion 166.

The statistical information deriving portion 168 derives statistical information 145 related to the combination of difference amounts of the elements with respect to the combination of one or more elements for the one or more different items and the one or more elements indicating one or more ranges for one or more numerical value items from the time-dependent change information 144 accumulated in the storage unit 14. For example, an average value of the difference amounts of the elements with the combination of elements after elapse of a predetermined period may be derived, or a probability (also referred to as morbidity rate) of being affected with a specific disease may be derived with respect to each combination of elements. The specific disease is, for example, diabetes, and the like. The morbidity rate can, for example, be derived as a probability that the element related to a specific numerical value item reaches a predetermined element after elapse of a predetermined period from the element indicating the difference amount of the elements between the element at a certain time point related to a specific numerical value item set in advance and the element after elapse of a predetermined period from the relevant certain time point. The specific numerical value item, for example, may be a blood glucose level, and the like. The predetermined element may be, for example, an element indicating the range set in advance such as 140 and over. The predetermined period may, for example, be a period set in advance such as one year, three years, five years, ten years, and the like. The deriving of the statistical information 145 by the statistical information deriving portion 168 may be, for example, carried out at a timing of at least one of the timing at which information is added to the PHR 141 and the timing set in advance. The timing set in advance may be timing each time the predetermined period has elapsed such as one day, one week, one month, one year, and the like.

The statistical information 145 derived here is stored in the storage unit 14. The statistical information 145 for future prediction is thereby prepared. For example, the medical interview information, and the like may be used to derive the statistical information 145 for when the daily habit is maintained and the statistical information 145 for when the daily habit is improved for the statistical information 145. The daily habit may be, for example, presence or absence of diet restriction, and the like.

The information adding portion 169 adds the information based on the statistical information 145 to the health information detected by the health information detecting portion 164. The information based on the statistical information 145 may be, for example, statistical information corresponding to the combination of elements indicating the state of the one user determined by the combination determining portion 163 of the statistical information 145. The health information appended with the information based on the statistical information 145 is, for example, output to the terminal devices 40, 50 through the communication line NTW by the output control portion 165. Thus, in the terminal devices 40, 50, the statistical information derived based on the accumulated information is presented at the display unit 22. As a result, the user is able to obtain more detailed health information.

The change determining portion 170 determines whether or not the time-dependent change amount of the statistical information 145 derived by the statistical information deriving portion 168 is greater than or equal to a predetermined amount. In the change determining portion 170, whether or not a relationship between the first statistical information 145 derived from the time-dependent change information 144 at the first timing and the second statistical information 145 derived from the time-dependent change information 144 at the second timing satisfies a relationship set in advance is determined. The second timing merely needs to be a timing later than the first timing. The first statistical information 145 is the statistical information related to the combination of difference amounts of the elements derived by the statistical information deriving portion 168 from the time-dependent change information 144 accumulated in the storage unit 14 at the first timing. The second statistical information 145 is the statistical information related to the combination of difference amounts of the elements derived by the statistical information deriving portion 168 from the time-dependent change information 144 accumulated in the storage unit 14 at the second timing.

A relationship in which a difference in the average values for the difference amounts of the elements related to one or more numerical value items before and after elapse of a predetermined period is greater than or equal to a predetermined value may be adopted, for example, for the relationship set in advance. For example, the predetermined period may be a period set in advance such as one year, three years, five years, ten years, and the like. The difference amount of the elements may be the separation amount of the ranges, for example. The predetermined value may be a value set in advance such as one. A relationship in which the difference in the probabilities that the element related to one or more specific numerical value items reaches a predetermined element after elapse of a predetermined period is greater than or equal to a predetermined value may be adopted for the relationship set in advance. For example, one or more specific numerical value items may be a blood glucose level, and the like. The predetermined element may be an element indicating the range set in advance, for example. The predetermined period may be a period set in advance such as one year, three years, five years, ten years, and the like, for example. The predetermined value may be a numerical value set in advance such as 1%, for example.

The annunciation control portion 171 causes an annunciation unit set in advance to make an annunciation corresponding to the determination result by the change determining portion 170. The annunciation corresponding to the determination result by the change determining portion 170 may be annunciation indicating the result obtained by determination that the relationship between the first statistical information 145 and the second statistical information 145 satisfies the relationship set in advance by the change determining portion 170, for example. The annunciation unit may be the display unit 22 of the management device 60, for example. Thus, an annunciation can be made to update to the health information taking into consideration newer tendency according to the annunciation corresponding to the change of the statistical information 145. As a result, for example, the administrator of the health support system 1 can recognize that the health information in the detection reference information 142a should be updated according to the change of the statistical information 145.

The signal receiving portion 172 receives a signal from a device satisfying the condition set in advance. The device satisfying the condition set in advance includes, for example, the hospital server 20, the management device 60, and the like. The condition set in advance may be, for example, a condition such as input of specific identification information.

The information appending portion 173 appends the information (also referred to as appending information) corresponding to the signal received by the signal receiving portion 172 to the health information detected by the health information detecting portion 164. The health information appended with the appending information is, for example, output to the terminal devices 40, 50 through the communication line NTW by the output control portion 165. The appending information may be, for example, information such as a comment on the one user input by the doctor at the hospital server 20. The health information that corresponds more with the status of each user thus can be presented at the terminal devices 40, 50. The appending information with respect to the one user is, for example, stored as the appending information 146 in the storage unit 14 by the control of the storage control portion 174. The appending information with respect to each user is, for example, stored in the appending information 146. The information appending portion 173 appends the appending information related to the one user among the appending information 146 stored in the storage unit 14 with respect to the health information each time the health information with respect to the one user is detected by the health information detecting portion 164. Thus, if there is no change in the comment from the doctor, for example, the simplification of the input operation by the doctor is achieved. In other words, the task of appending further information to the health information can be simplified.

The information updating portion 175 updates the health information contained in the detection reference information 142a according to the signal received by the signal receiving portion 172. For example, a mode in which the administrator of the health support system 1, who has visually recognized the annunciation in the display unit 22 of the management device 60 serving as the annunciation unit, updates the health information in the detection reference information 142a is considered. Thus, the health information can be updated such that the health information taking into consideration newer tendency is presented according to the change of the statistical information 145, for example.

### <(1-2-3-3) Functional Configuration of Terminal Device>

The display control portion 261 controls the visual output of various types of information at the display unit 22. For example, the various types of information include health information input to the terminal devices 40, 50 through the communication line NTW from the DC server 10. If the appending information is appended to the health information by the information appending portion 173, for example, the health information appended with the appending information is visually output at the display unit 22 by the control of the display control portion 261. For example, if the information based on the statistical information 145 is added to the health information by the information adding portion 169, the health information appended with the information based on the statistical information 145 is visually output at the display unit 22 by the control of the display control portion 261.

The transmission control portion 262 controls the transmission of the information (also referred to as input information) input according to the operation by the user of the operation unit 21 of the terminal devices 40, 50 to the DC server 10. For example, the input information is transmitted to the DC server 10 through the communication line NTW by the transmission control portion 262, and the input information is stored in the storage unit 14 by the storage control portion 174. The input information includes, for example, information indicating various numerical values for the state of the user obtained by the measurement performed by the user himself/herself using various devices at home, and the like. The various numerical values include numerical values related to, for example, blood pressure, blood glucose level, and the like.

### (1-3) Transition of Screen in Health Support Operation

In the present preferred embodiment, the user of the health support system 1 accesses the DC server 10 via the communication line NTW using the terminal devices 40, 50 to execute the operation (also referred to as health support operation) related to the health support function. The screen displayed on the display unit 22 of the terminal devices 40, 50 in the health support operation and the transition thereof will be described. An example of performing the health support related to diabetes will be described by way of example.

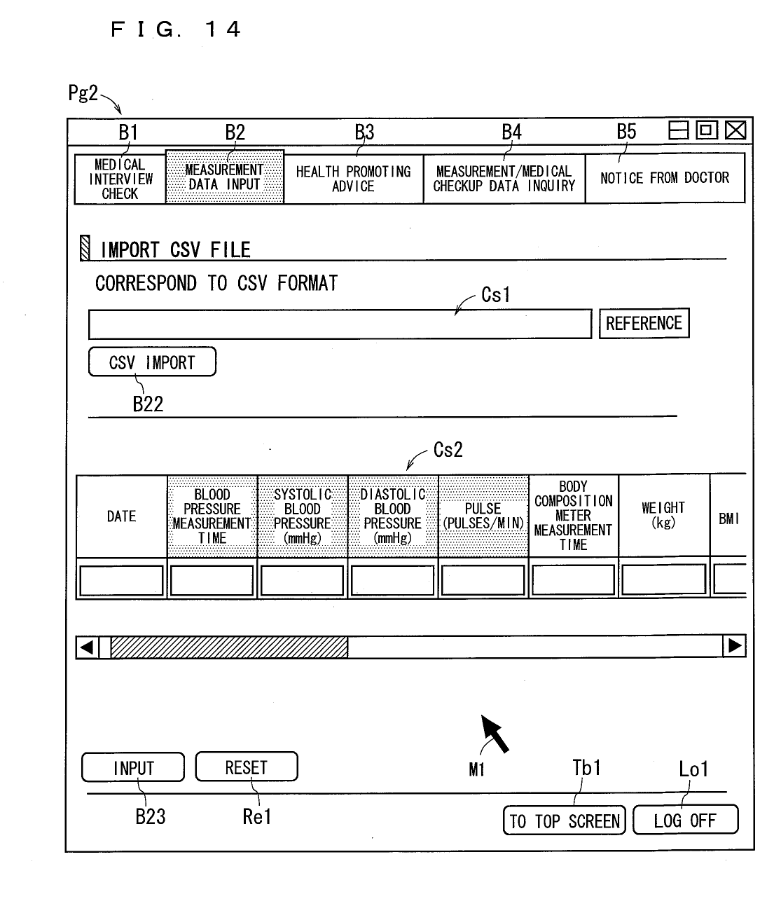

FIG. 11 to FIG. 17 are views illustrating screens displayed on the display unit 22 of the terminal device 40, 50 in the health support operation.

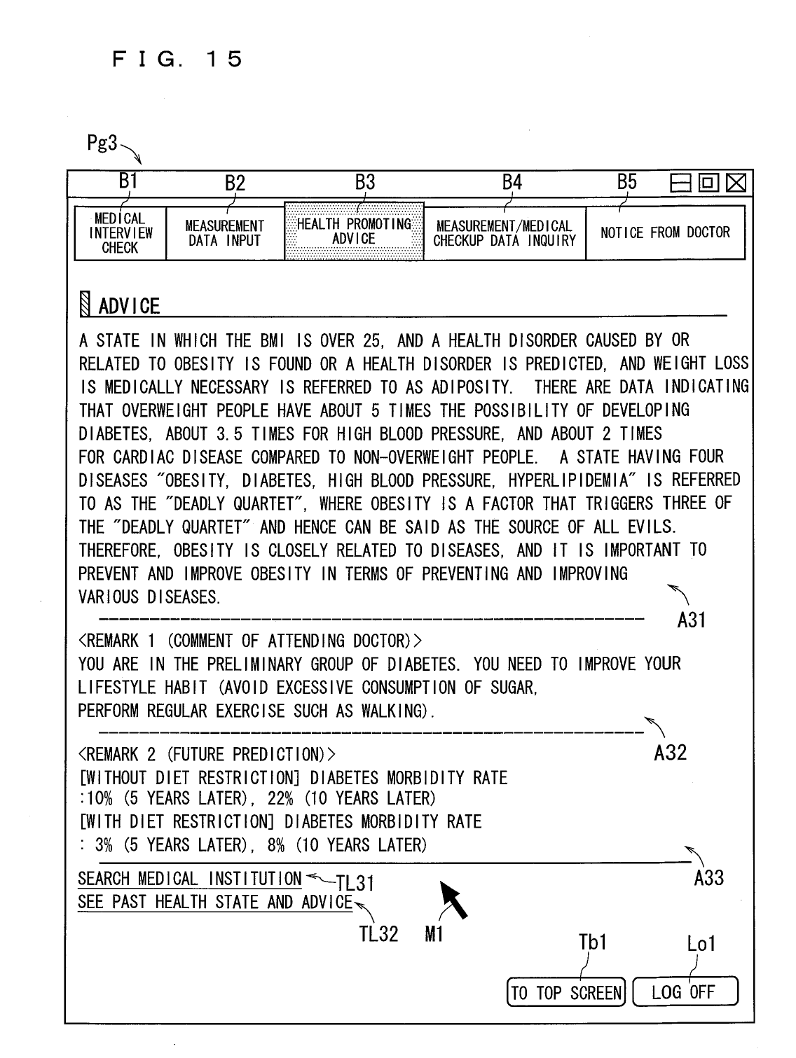

FIG. 11 is a view schematically illustrating a top screen Tp1 that is displayed first when the DC server 10 is accessed at the terminal device 40, 50. In the top screen Tp1, the content of services related to the health support provided by the health support system 1 is introduced. Furthermore, in the top screen Tp1, when a button BT1 is pushed or a text link TL1 is specified with a mouse pointer M1, a screen displayed on the display unit 22 shifts to a screen presenting questions to ask to check the degree of risk of diabetes. In this case, when the replies to the questions are input by the user on the screen, the degree of risk of the diabetes is determined, and the determination result may be displayed. Furthermore, in the top screen Tp1, when a button BT2 is pushed with the mouse pointer M1, for example, by the user, the screen displayed on the display unit 22 shifts to a screen (also referred to as search screen) Pr1 for searching the medical institution as shown in FIG. 12. The user thus can search for the medical institution corresponding to his/her state according to the determination result related to the degree of risk of the diabetes, and go for consultation at the relevant medical institution.

When going for consultation at the medical institution, or after the medical interview, examination, consultation, and the like are finished, the user enters a login ID and a password serving as identification information of the user to a login field Li1 of the top screen Tp1 and pushes the login button to login to a state of receiving services related to the health support. The user of the terminal device 40, 50 can be specified by such login. The login ID and the password are given to the user from the medical institution participating in the health support system 1, for example. When the login is carried out at each terminal device 30 to 50 at the time of the consultation or after the consultation in the medical institution, the screen displayed on the display unit 22 shifts to a screen (also referred to as medical interview screen) Pg1 for carrying out the medical interview as shown in FIG. 13. For example, when going for consultation at the medical institution, the replies made in the medical interview prior to the consultation are transmitted to the hospital server 20 from the terminal device 30 such as a tablet, and the like through the communication line NTW, and stored in the electronic medical chart DB 241. After the consultation at the medical institution, the user can input a new reply corresponding to the change in his/her state through the terminal device 50 such as a Smartphone, and the like with respect to the medical interview. The screen shifts to the medical interview screen Pg1 also when the button BT3 is pushed with the mouse pointer M1 after the login is carried out in the top screen Tp1.

FIG. 12 is a view schematically illustrating the search screen Pr1. In the search screen Pr1, the text link, and the like of a desired prefecture name is specified by the mouse pointer M1 so that the medical institution specializing in diabetes in the desired prefecture is displayed. The user is then able to grasp the closest medical institution that specializes in diabetes. Furthermore, when a button Tb1 at the lower right is pushed with the mouse pointer M1 in the search screen Pr1, the screen displayed on the display unit 22 returns to the top screen Tp1. When a button Rb1 at the lower right is pushed with the mouse pointer M1 in the search screen Pr1, the search result or the information being searched is cleared, and the screen displayed on the display unit 22 returns to an initial screen of the search screen Pr1.

FIG. 13 is a view schematically illustrating the medical interview screen Pg1. In the medical interview screen Pg1, either one of a radio button N1 indicating “NO” or a radio button Y1 indicating “YES” can be selectively selected with the mouse pointer M1 with respect to each question related to the medical interview. Each question may correspond to the nine items related to the medical interview in the detection reference information 142a, for example. When a button Ch1 at the lower left is pushed with the mouse pointer M1 with either one of the radio buttons N1, Y1 selected with respect to each question in the medical interview screen Pg1, the reply to each question related to the medical interview is input. In this case, for example, when receiving consultation at the medical institution, the medical interview information indicating the reply to each question related to the medical interview on the medical interview screen Pg1 is stored in the electronic medical chart DB 241. The medical interview information is thereby easily stored in the electronic medical chart DB 241. In the case where the medical interview, examination, consultation, and the like at the medical institution are finished, the medical interview information indicating the reply to each question related to the medical interview on the medical interview screen Pg1 is stored in the PHR 141.

In the medical interview screen Pg1, when a button Re1 at the lower left is pushed with the mouse pointer M1, the state in which either one of the radio buttons N1, Y1 is selected with respect to each question is reset. In this case, for example, a state in which the radio buttons Y1 or the radio buttons N1 are selected with respect to all the questions may be obtained by the reset. Furthermore, when a button Lo1 at the lower right is pushed with the mouse pointer M1 in the medical interview screen Pg1, log off in which the state of being provided with the services related to the health support is cancelled is carried out, and the screen displayed on the display unit 22 returns to the top screen Tp1.

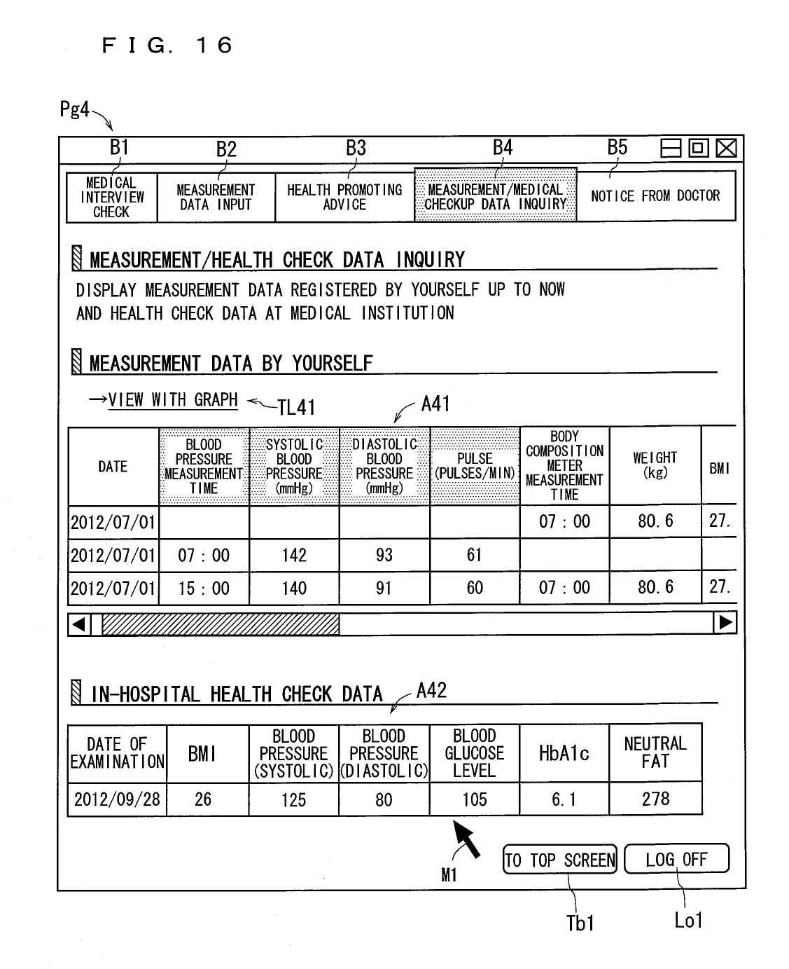

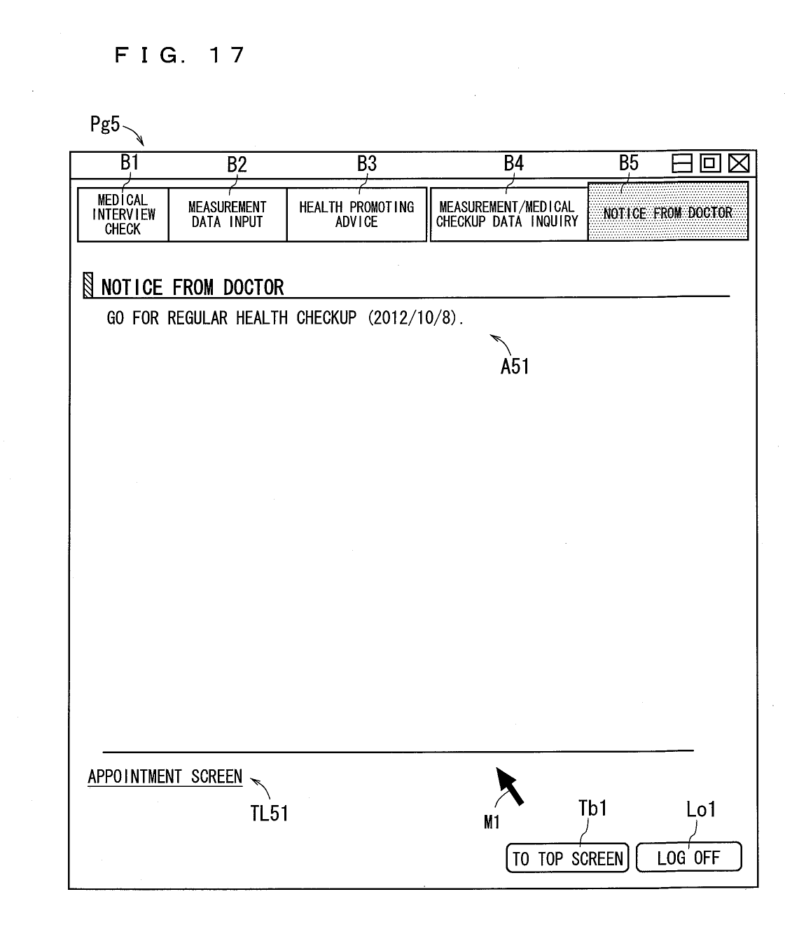

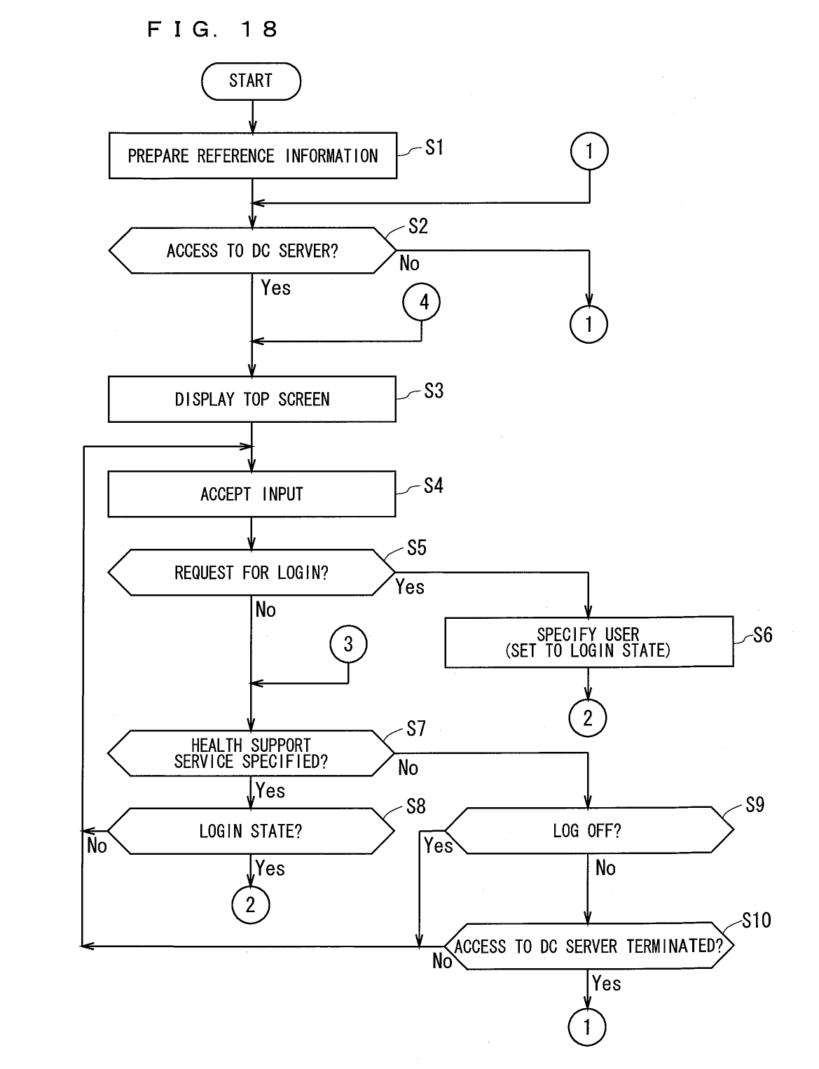

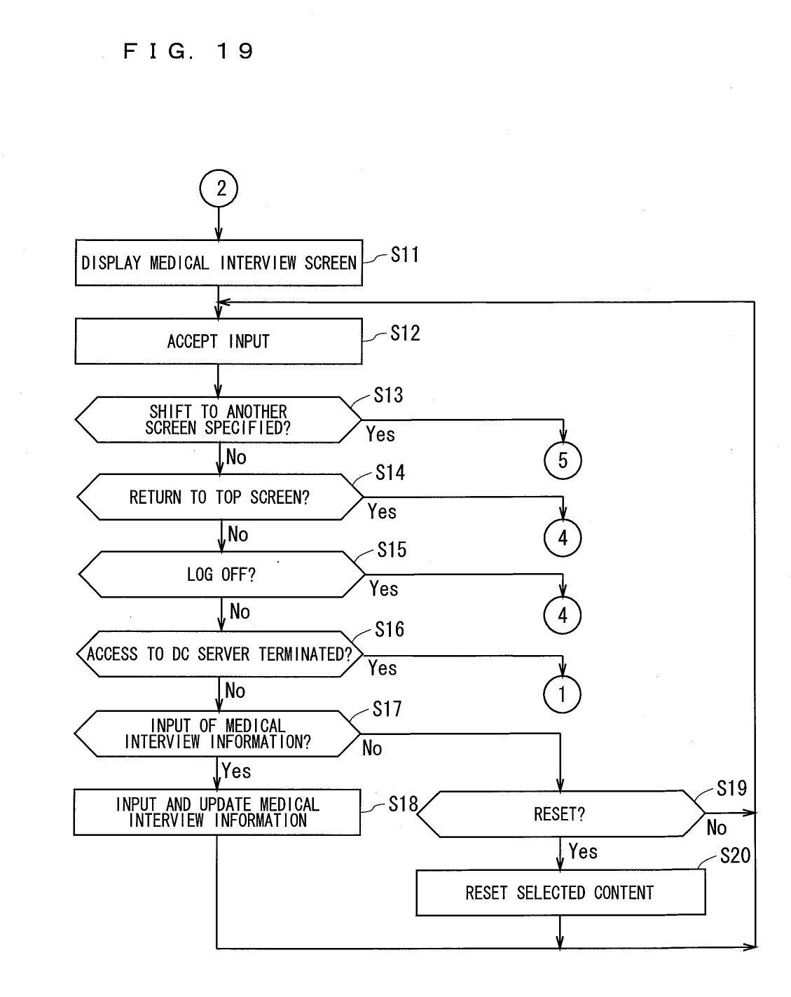

When one of the buttons B2 to B5 at the upper part is specified by the mouse pointer M1 in the medical interview screen Pg1, the screen displayed on the display unit 22 shifts to screens Pg2 to Pg5 corresponding to the specified button. Specifically, for example, when the button B2 is specified by the mouse pointer M1, the screen displayed on the display unit 22 shifts to a screen (also referred to as data input screen) Pg2 for the user to input the measured data as shown in FIG. 14. For example, when the button B3 is specified by the mouse pointer M1, the screen displayed on the display unit 22 shifts to a screen (also referred to as advice presenting screen) Pg3 for presenting an advice to promote the health of the user as shown in FIG. 15. For example, when the button B4 is specified by the mouse pointer M1, the screen displayed on the display unit 22 shifts to a screen (also referred to as data inquiry screen) Pg4 for inquiring the data on the measurement and the medical checkup related to the user as shown in FIG. 16. For example, when the button B5 is specified by the mouse pointer M1, the screen displayed on the display unit 22 shifts to a screen (also referred to as notice screen) Pg5 for displaying the notice from the doctor as shown in FIG. 17. Each screen Pg2 to Pg5 will be hereinafter described.

FIG. 14 is a view schematically illustrating the data input screen Pg2. In the data input screen Pg2, the data (also referred to as measurement data) measured by the user can be input. For example, when the button B22 is pushed with the mouse pointer M1 with the numerical value related to each numerical value item measured by the user entered in the entry field Cs1, the numerical value related to each numerical value item measured by the user is input as measurement data of CSV format. When the button B23 is pushed with the numerical value related to each numerical value item measured by the user entered in the entry field Cs2, the numerical value related to each numerical value item measured by the user is input as measurement data. The input information serving as the measurement data indicating the numerical value related to each numerical value item being input is registered in the PHR 141 by the transmission control portion 262 and the storage control portion 174. In the data input screen Pg2, when the button Re1 at the lower left is pushed with the mouse pointer M1, all the numerical values entered to the entry fields Cs1, Cs2 are erased. Furthermore, when the button B1 at the upper part is specified by the mouse pointer M1 in the data input screen Pg2, the screen displayed on the display unit 22 shifts to the medical interview screen Pg1 shown in FIG. 13.

FIG. 15 is a view schematically illustrating the advice presenting screen Pg3. In the advice presenting screen Pg3, the health information detected by the health information detecting portion 164 is visually output. For example, the advice to the user serving as the health information detected by the health information detecting portion 164 is presented in a display field A31 of the advice presenting screen Pg3. The user thus can obtain health information such as an appropriate advice, and the like corresponding to his/her state. When a comment related to the difference is displayed in the display field A31 of the advice presenting screen Pg3, this encourages the user if the comment related to the difference includes content praising the effort of the user. The content praising the effort of the user includes, for example, sentences such as “Significantly improved. Keep up the good work and you will get a healthy body”, and the like. The advice may also include, for example, information indicating the examination item and the medical interview item necessary for providing more detailed health information, and the like. The user is thus able to easily grasp a method for obtaining more detailed health information.

For example, in the display field A32 of the advice presenting screen Pg3, the appending information appended to the health information by the information appending portion 173 is visually output. FIG. 15 shows one example in which a comment for the user input by the doctor is presented as the appending information is shown. The user thus can obtain the health information that corresponds more with the state including the comment of the doctor corresponding to his/her state.

For example, in the display field A33 of the advice presenting screen Pg3, the information based on the statistical information 145 added with respect to the health information by the information adding portion 169 is visually output. In FIG. 15, one example in which the future predictions such as the morbidity rates of the diabetes five years later and ten years later are presented with respect to the presence and absence of diet restriction as information based on the statistical information 145 respectively is shown. The user thus can obtain the actual feeling of to what extent of the effect can be obtained by what extent of improvement in daily habit, and the like.

The user checks the content of the advice presenting screen Pg3, and specifies the text link TL31 of the advice presenting screen Pg3 with the mouse pointer M1 to display the search screen Pr1 on the display unit 22 if there is a need to go for consultation at the medical institution. Another medical institution different from the medical institution the user has already had a consultation thus can be searched. The user can browse through the health information including the past health state and advice serving as past history by specifying the text link TL32 of the advice presenting screen Pg3 with the mouse pointer M1.

The doctor generally performs the necessary examination and carries out consultation while referencing the results of the medical interview for each patient, and enters the results of the medical interview, examination, and consultation in the electronic medical chart. In this case, the result of the examination is not obtained in real time, and thus the patient needs to go in for re-consultation at a later date so that the result of the diagnosis based on the result of the examination can be told to the patient along with the result of the examination in the re-consultation. In the health support system 1 according to the present preferred embodiment, on the other hand, the information indicating the results related to the medical interview, examination, measurement, consultation, and the like for each user are stored in the electronic medical chart DB 241 by the doctor, and the like. The health information including the advice to the patient serving as the user detected by comprehensively using the information indicating the results related to the medical interview, examination, measurement, consultation, and the like through the DC server 10 is provided to the user by the advice presenting screen Pg3, and the like. The patient serving as the user thus can easily obtain the health information based on the results related to the medical interview, examination, measurement, consultation and the like without going in for re-consultation. Therefore, for example, the convenience of the patients serving as wide range of users having geographical and temporal restrictions can be enhanced.

FIG. 16 is a view schematically illustrating the data inquiry screen Pg4. In the data inquiry screen Pg4, the various types of data of the user himself/herself stored in the PHR 141 are visually output.

For example, in the display field A41 of the data inquiry screen Pg4, the data measured by the user himself/herself input by the data input screen Pg2 is visually output. In FIG. 16, one example in which the data measured by the user himself/herself is displayed in a form of a list described for every measurement date and time is shown. For example, the time-dependent change of the data measured by the user himself/herself is displayed in a form of a graph by specifying the text link TL41 with the mouse pointer M1. The user thus can easily check the data measured by the user himself/herself.

For example, the information related to the examination result stored in the PHR 141 from the electronic medical chart DB 241 of the hospital server 20 is visually output in the display field A42 of the data inquiry screen Pg4. In FIG. 16, one example in which the information related to the examination result is displayed in a form of a list described for every measurement date and time is shown. The time-dependent change of the information related to the examination result may also be displayed in a form of a graph, for example. The various types of information displayed in the data inquiry screen Pg4 may be generated based on the various types of information such as the PHR 141 stored in the storage unit 14 by the control unit 16, for example. The user thus can easily check the information related to the examination result of the user himself/herself.

FIG. 17 is a view schematically illustrating the notice screen Pg5. In the notice screen Pg5, the information related to a notice from the doctor is visually displayed in the display field A51 based on the information stored in the PHR 141 through the electronic medical chart DB 241 according to the input of the doctor at the hospital server 20. In the notice screen Pg5, a screen (also referred to as appointment screen) for making an appointment for consultation at the medical institution may be presented when the text link TL51 is specified by the mouse pointer M1.

### (1-4) Process Flow of Health Support System

FIG. 18 to FIG. 25 are flowcharts illustrating a process flow related to the health support operation in the health support system 1. The process flow is realized by a cooperative operation of the control unit 16 in the DC server 10 and the control unit 26 in the terminal device 40, 50. An example in which one user accesses the DC server 10 from the terminal device 50 after the consultation at the medical institution will be described below by way of example.

In step S1 of FIG. 18, a state in which the detection reference information 142a serving as the first reference information is stored in the storage unit 14 is set by the control unit 16.

In step S2, whether or not an access is made from the terminal device 50 to the DC server 10 is determined by the control unit 16. The determination of step S2 is repeated until access is made from the terminal device 50 to the DC server 10, and the process proceeds to step S3 if access is made from the terminal device 50 to the DC server 10.

In step S3, the top screen Tp1 (FIG. 11) is displayed on the display unit 22 of the terminal device 50 by the control unit 16, 26. The login button of the top screen Tp1 is changed to the logoff button after the login state is set in step S6, to be described later, and until logoff is carried out.

In step S4, various inputs on the top screen Tp1 are accepted by the control unit 16.

In step S5, whether or not the request for login is made by the pushing of the login button with the mouse pointer M1 in the top screen Tp1 in a state where the identification information such as the login ID, the password, and the like are entered to the login field Li1 is determined by the control unit 16. The process proceeds to step S6 if the request for login is made, and the process proceeds to step S7 if the request for login is not made.

In step S6, one user of the terminal device 50 is specified based on the identification information input from the terminal device 50 at the time of request for login by the control unit 16. Thus, a state in which the login is made (also referred to as login state) is set by the control unit 16, and the process proceeds to step S11 of FIG. 19.

In step S7, whether or not the button BT3 is pushed with the mouse pointer M1 in the top screen Tp1 is determined by the control unit 16. The process proceeds to step S8 if the button BT3 is pushed. The process proceeds to step S9 if the button BT3 is not pushed.

In step S8, whether or not set to the login state is determined by the control unit 16. The process proceeds to step S11 of FIG. 19 if already set to the login state. The process returns to step S4 if not set to the login state.

In step S9, whether or not the logoff is carried out at the terminal device 50 is determined by the control unit 16. If the logoff button is pushed with the mouse pointer M1 while being set to the login state, the login state is cancelled and the process returns to step S4. If not set to the login state or if the logoff button is not pushed with the mouse pointer M1, the process proceeds to step S10.

In step S10, whether or not the access from the terminal device 50 to the DC server 10 is terminated is determined by the control unit 16. The process returns to step S4 if the access from the terminal device 50 to the DC server 10 is not terminated. The process returns to step S2 if the access from the terminal device 50 to the DC server 10 is terminated.

In step S11 of FIG. 19, the medical interview screen Pg1 (FIG. 13) is displayed on the display unit 22 of the terminal device 50 by the control unit 16, 26.

In step S12, various inputs on the medical interview screen Pg1 are accepted by the control unit 16.

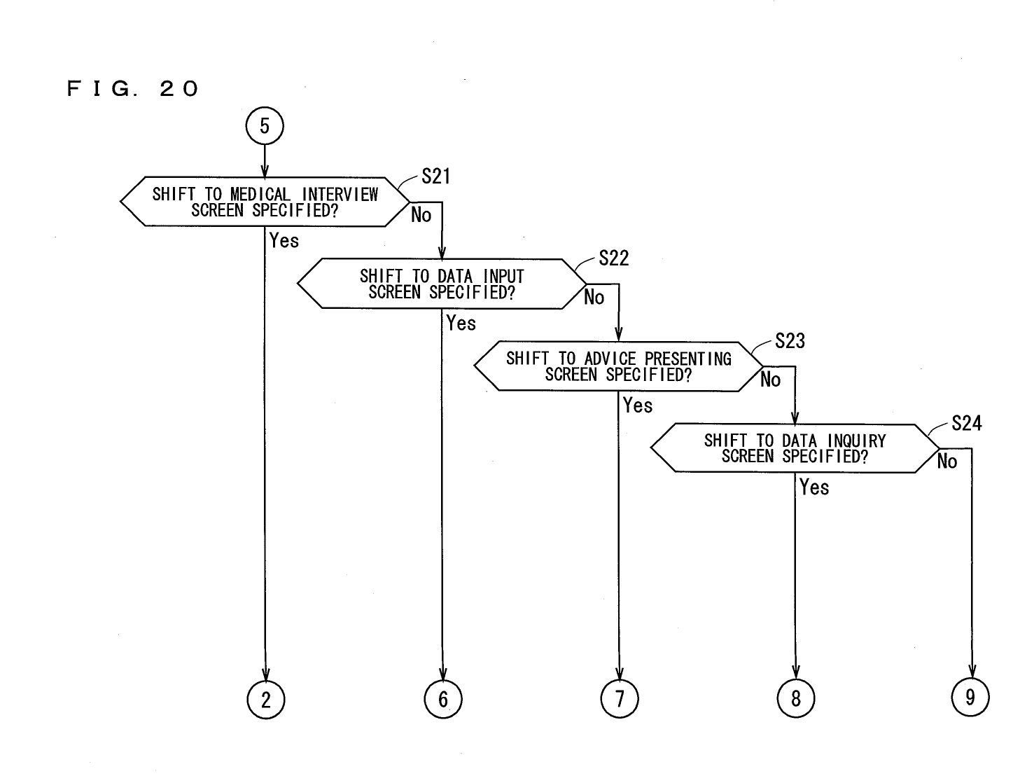

In step S13, whether or not the shift to another screen Pg2 to Pg5 is specified by the specification of one of the buttons B2 to B5 on the medical interview screen Pg1 by the mouse pointer M1 is determined by the control unit 16. The process proceeds to step S14 if the shift to another screen Pg2 to Pg5 is not specified. The process proceeds to step S21 of FIG. 20 if the shift to another screen Pg2 to Pg5 is specified.

In step S14, whether or not to return to the TOP screen Tp1 is determined by the control unit 16. The process proceeds to step S15 if the button Tb1 on the medical interview screen Pg1 is not pushed with the mouse pointer M1. The process returns to step S3 of FIG. 18 if the button Tb1 is pushed with the mouse pointer M1.

In step S15, whether or not the logoff is carried out at the terminal device 50 is determined by the control unit 16. When the button Lo1 on the medical interview screen Pg1 is pushed with the mouse pointer M1, the login state is cancelled and the process returns to step S3 of FIG. 18. The process proceeds to step S16 if the button Lo1 is not pushed with the mouse pointer M1.

Similar to step S10 of FIG. 18, whether or not the access from the terminal device 50 to the DC server 10 is terminated is determined by the control unit 16 in step S16. The process proceeds to step S17 if the access from the terminal device 50 to the DC server 10 is not terminated. The process returns to step S2 of FIG. 18 if the access from the terminal device 50 to the DC server 10 is terminated.

In step S17, when the button Ch1 on the medical interview screen Pg1 is pushed, whether or not the input of the medical interview information is specified is determined by the control unit 16. The process proceeds to step S18 if the input of the medical interview information is specified. The process proceeds to step S19 if the input of the medical interview information is not specified.

In step S18, the medical interview information indicating the reply to each question related to the medical interview on the medical interview screen Pg1 is stored in the PHR 141 by the control unit 16 to input and update the medical interview information related to the one user. The process then returns to step S12.

In step S19, whether or not the reset is specified by the pushing of the button Re1 on the medical interview screen Pg1 is determined by the control unit 16. The process returns to step S12 if the reset is not specified. The process proceeds to step S20 if the reset is specified.

In step S20, the selected content with respect to each question is reset on the medical interview screen Pg1 by the control unit 16, and the process returns to step S12.

In step S21 of FIG. 20, whether or not the shift to the medical interview screen Pg1 is specified by the specification of the button B1 by the mouse pointer M1 is determined by the control unit 16. The process proceeds to step S11 of FIG. 19 if the shift to the medical interview screen Pg1 is specified. The process proceeds to step S22 if the shift to the medical interview screen Pg1 is not specified.

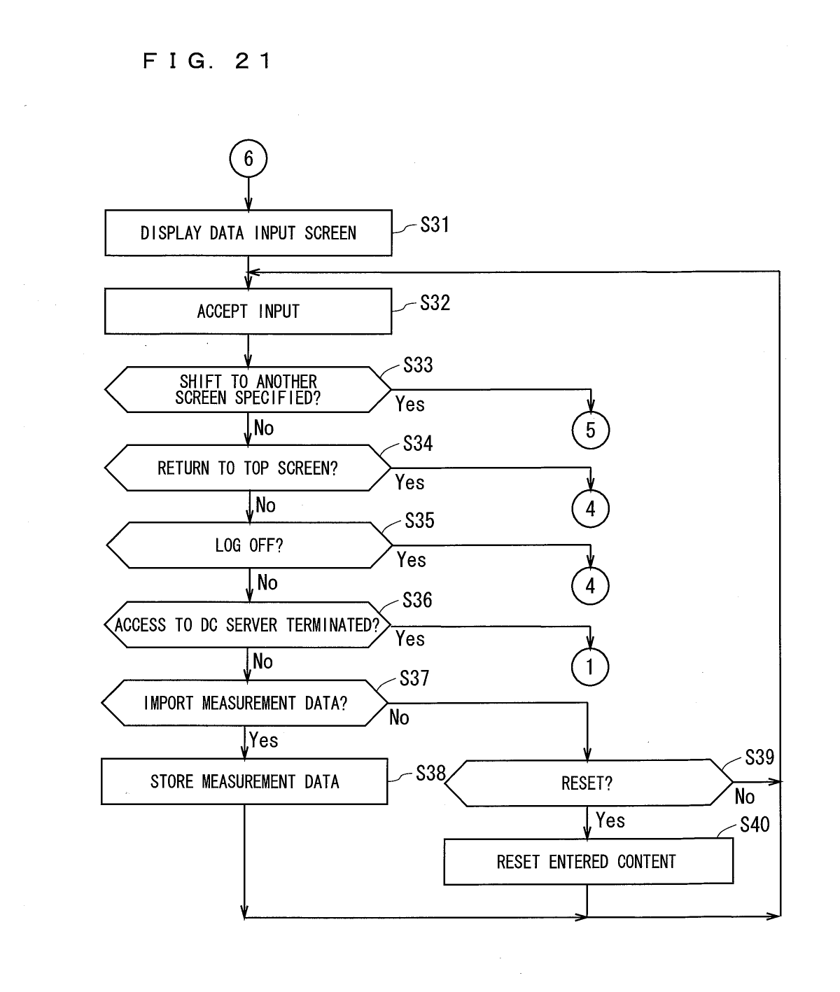

In step S22, whether or not the shift to the data input screen Pg2 is specified by the specification of the button B2 by the mouse pointer M1 is determined by the control unit 16. The process proceeds to step S31 of FIG. 21 if the shift to the data input screen Pg2 is specified. The process proceeds to step S23 if the shift to the data input screen Pg2 is not specified.

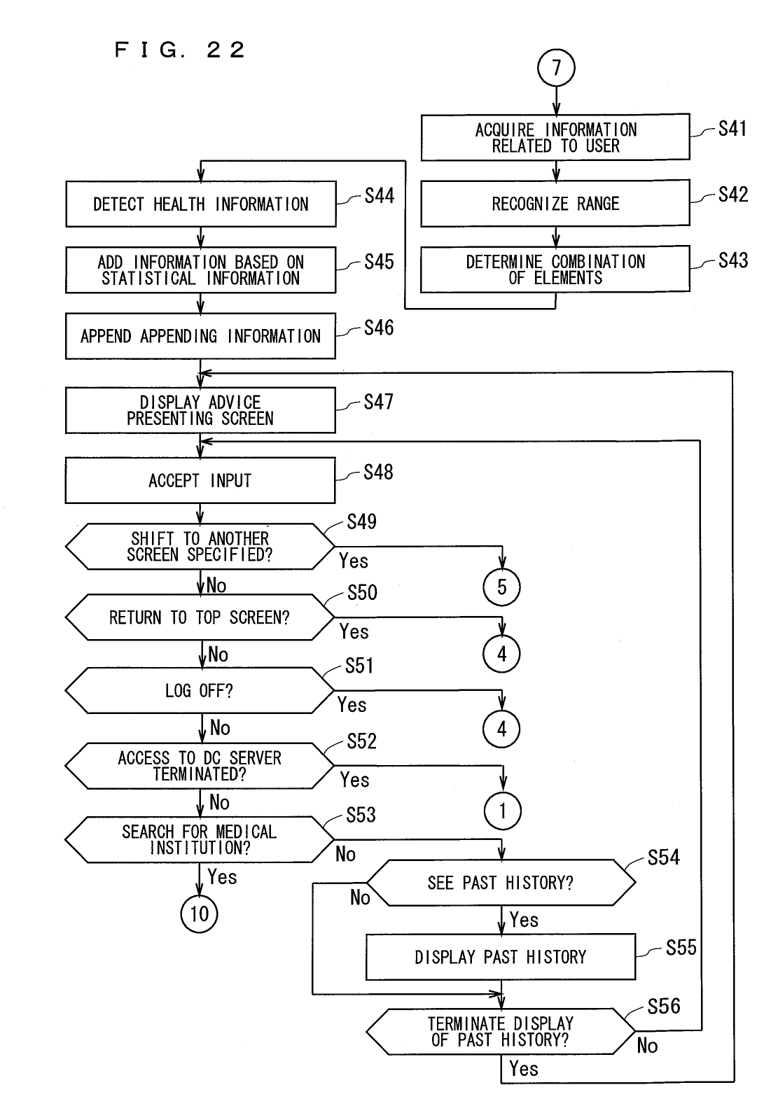

In step S23, whether or not the shift to the advice presenting screen Pg3 is specified by the specification of the button B3 by the mouse pointer M1 is determined by the control unit 16. The process proceeds to step S41 of FIG. 22 if the shift to the advice presenting screen Pg3 is specified. The process proceeds to step S24 if the shift to the advice presenting screen Pg3 is not specified.

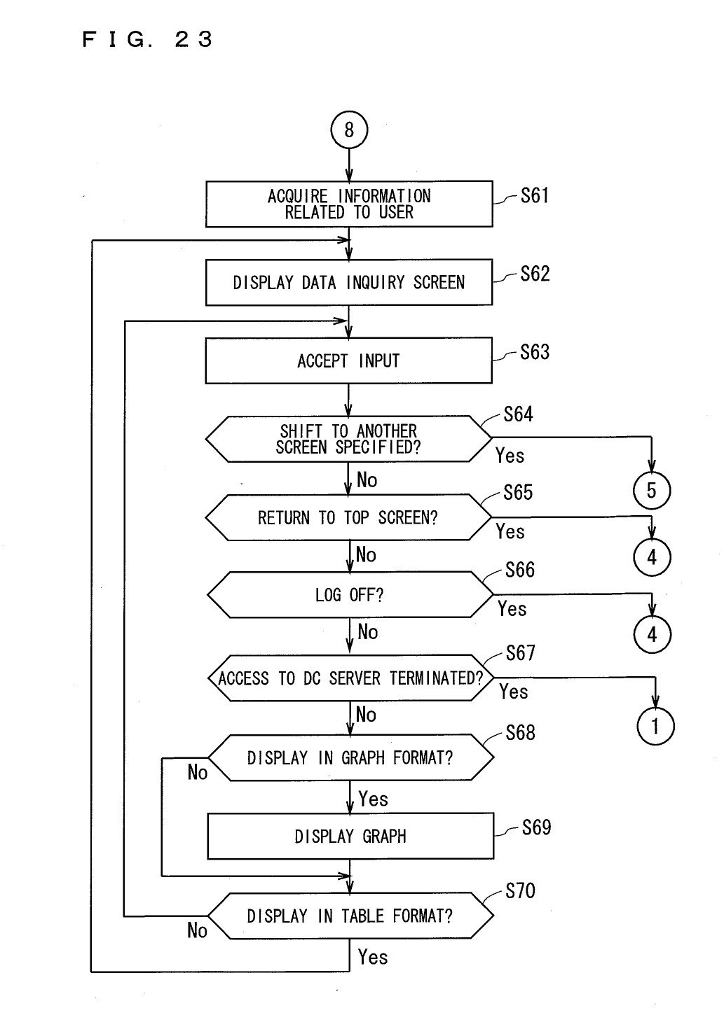

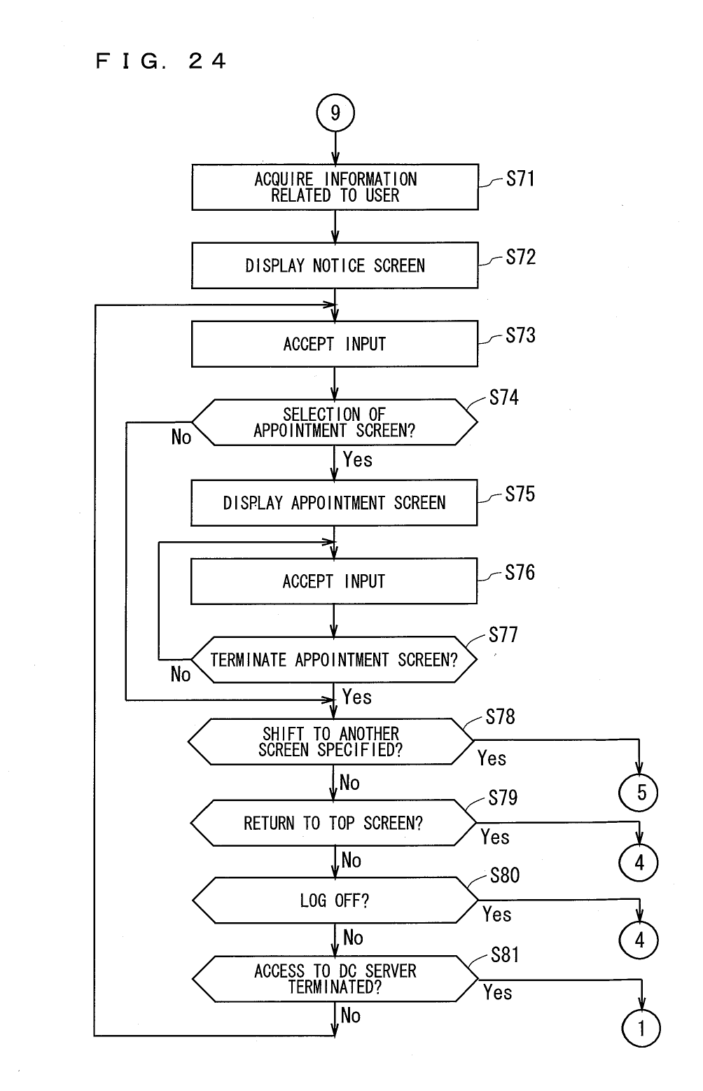

In step S24, whether or not the shift to the data inquiry screen Pg4 is specified by the specification of the button B4 by the mouse pointer M1 is determined by the control unit 16. The process proceeds to step S61 of FIG. 23 if the shift to the data inquiry screen Pg4 is specified. If the shift to the data inquiry screen Pg4 is not specified, the process proceeds to step S71 of FIG. 24 assuming the shift to the notice screen Pg5 is specified.

In step S31 of FIG. 21, the data input screen Pg2 (FIG. 14) is displayed on the display unit 22 of the terminal device 50 by the control unit 16, 26.

In step S32, various inputs on the data input screen Pg2 are accepted by the control unit 16.

In step S33, whether or not the shift to another screen Pg1, Pg3 to Pg5 is specified by the specification of one of the buttons B1, B3 to B5 on the data input screen Pg2 by the mouse pointer M1 is determined by the control unit 16. The process proceeds to step S34 if the shift to another screen Pg1, Pg3 to Pg5 is not specified. The process proceeds to step S21 of FIG. 20 if the shift to another screen Pg1, Pg3 to Pg5 is specified.

In step S34, whether or not to return to the TOP screen Tp1 is determined by the control unit 16. The process proceeds to step S35 if the button Tb1 on the data input screen Pg2 is not pushed with the mouse pointer M1. The process returns to step S3 of FIG. 18 if the button Tb1 is pushed with the mouse pointer M1.

In step S35, whether or not the logoff is carried out at the terminal device 50 is determined by the control unit 16. If the button Lo1 on the data input screen Pg2 is pushed with the mouse pointer M1, the login state is cancelled and the process returns to step S3 of FIG. 18. If the button Lo1 is not pushed with the mouse pointer M1, the process proceeds to step S36.

In step S36, whether or not the access from the terminal device 50 to the DC server 10 is terminated is determined by the control unit 16, similar to step S10 of FIG. 18. The process proceeds to step S37 if the access from the terminal device 50 to the DC server 10 is not terminated. The process returns to step S2 of FIG. 18 if the access from the terminal device 50 to the DC server 10 is terminated.

In step S37, whether or not the import of measurement data is specified by the pushing of the button B22 or the button B23 on the data input screen Pg2 is determined by the control unit 16. The process proceeds to step S38 if the import of the measurement data is specified. The process proceeds to step S39 if the import of the measurement data is not specified.

In step S38, the numerical value entered to the entry field Cs1 or the entry field Cs2 of the data input screen Pg2 is stored in the PHR 141 as the measurement data by the control unit 16.

In step S39, whether or not the reset is specified by the pushing of the button Re1 on the data input screen Pg2 is determined by the control unit 16. The process returns to step S32 if the reset is not specified. The process proceeds to step S40 if the reset is specified.

In step S40, the numerical values entered to the entry fields Cs1, Cs2 on the data input screen Pg2 are reset by the control unit 16, and the process returns to step S32.

In step S41 of FIG. 22, the numerical value related to the state of the one user is acquired for each item of one or more numerical value items, and the element related to the one user is acquired for each item of one or more different items different from the one or more numerical value items by the data acquiring portion 161 of the control unit 16. The element related to the one user can be acquired from the PHR 141.

In step S42, the element indicating the range to which the numerical value acquired in step S41 belongs is recognized for each item in one or more numerical value items by referencing the range reference information 142b by the range recognizing portion 162 of the control unit 16.

In step S43, the combination of one or more elements acquired for one or more different items in step S41 and the element indicating one or more ranges recognized for one or more numerical value items in step S42 is determined by the combination determining portion 163 of the control unit 16. That is, the combination of elements is determined as the combination of elements indicating the state of the one user.

In step S44, the health information corresponding to the combination of elements indicating the state of the one user determined in step S43 is detected by referencing the detection reference information 142a by the health information detecting portion 164 of the control unit 16. The health information corresponding to the combination of difference amounts of the elements related to the numerical values of the one user recognized by the difference amount recognizing portion 166 may be detected here by referencing the detection reference information 142a.

In step S45, the information based on the statistical information 145 is added to the health information detected in step S44 by the information adding portion 169 of the control unit 16. The statistical information 145 may be derived by the statistical information deriving portion 168 and stored in the storage unit 14.

In step S46, the appending information related to the one user is appended by the information appending portion 173 of the control unit 16. The appending information related to the one user may be information corresponding to the signal received by the signal receiving portion 172, and for example, may be information contained in the appending information 146 stored in the storage unit 14.

In step S47, the advice presenting screen Pg3 (FIG. 15) is displayed on the display unit 22 of the terminal device 50 by the output control portion 165 of the control unit 16 and the display control portion 261 of the control unit 26. In the advice presenting screen Pg3, the health information detected in step S44 is visually output. In this case, for example, the information added in step S45 and the information appended in step S46 can be simultaneously displayed.

In step S48, various inputs on the advice presenting screen Pg3 are accepted by the control unit 16.

In step S49, whether or not the shift to another screen Pg1, Pg2, Pg4, Pg5 is specified by the specification of one of the buttons B1, B2, B4, B5 on the advice presenting screen Pg3 by the mouse pointer M1 is determined by the control unit 16. The process proceeds to step S50 if the shift to another screen Pg1, Pg2, Pg4, Pg5 is not specified. The process proceeds to step S21 of FIG. 20 if the shift to another screen Pg1, Pg2, Pg4, Pg5 is specified.

In step S50, whether or not to return to the TOP screen Tp1 is determined by the control unit 16. The process proceeds to step S51 if the button Tb1 on the advice presenting screen Pg3 is not pushed with the mouse pointer M1. The process returns to step S3 of FIG. 18 if the button Tb1 is pushed with the mouse pointer M1.

In step S51, whether or not the logoff is carried out at the terminal device 50 is determined by the control unit 16. If the button Lo1 on the advice presenting screen Pg3 is pushed with the mouse pointer M1, the login state is cancelled and the process returns to step S3 of FIG. 18. If the button Lo1 is not pushed with the mouse pointer M1, the process proceeds to step S52.

In step S52, whether or not the access from the terminal device 50 to the DC server 10 is terminated is determined by the control unit 16, similar to step S10 of FIG. 18. The process proceeds to step S53 if the access from the terminal device 50 to the DC server 10 is not terminated. The process returns to step S2 of FIG. 18 if the access from the terminal device 50 to the DC server 10 is terminated.

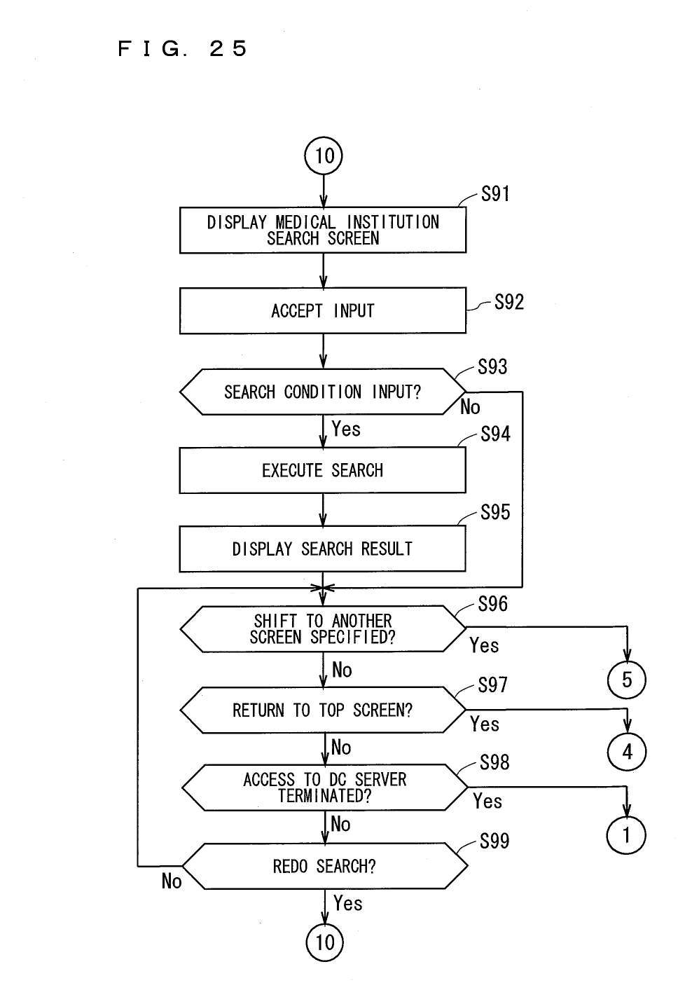

In step S53, whether or not the text link TL31 on the advice presenting screen Pg3 is specified by the mouse pointer M1 is determined by the control unit 16. The process proceeds to step S54 if the text link TL31 is not specified by the mouse pointer M1. The process proceeds to step S91 of FIG. 25 if the text link TL31 is specified by the mouse pointer M1.

In step S54, whether or not the text link TL32 on the advice presenting screen Pg3 is specified by the mouse pointer M1 is determined by the control unit 16. The process proceeds to step S55 if the text link TL32 is specified by the mouse pointer M1. The process proceeds to step S56 if the text link TL32 is not specified by the mouse pointer M1.

In step S55, the health information including the past health state serving as the past history and advice is displayed on the advice presenting screen Pg3 by the output control portion 165 of the control unit 16 and the display control portion 261 of the control unit 26. In this case, the text link TL32 is switched to a text link (also referred to as history terminating link) “see current health state and advice” for terminating the history display.

In step S56, whether or not the history terminating link for terminating the history display on the advice presenting screen Pg3 is specified is determined by the control unit 16. The process returns to step S48 if the history terminating link is not specified by the mouse pointer M1. The process returns to step S47 if the history terminating link is specified by the mouse pointer M1.

In step S61 of FIG. 23, the data of measurement and medical checkup related to the one user are acquired by the control unit 16. The data of measurement and medical checkup related to the one user may be acquired from the PHR 141.

In step S62, the data inquiry screen Pg4 (FIG. 16) is displayed on the display unit 22 of the terminal device 50 by the output control portion 165 of the control unit 16 and display control portion 261 of the control unit 26. In the data inquiry screen Pg4, the data of measurement and medical checkup related to the one user acquired in step S61 are visually output.

In step S63, various inputs on the data inquiry screen Pg4 are accepted by the control unit 16.

In step S64, whether or not the shift to another screen Pg1 to Pg3, Pg5 is specified by the specification of one of the buttons B1 to B3, B5 on the data inquiry screen Pg4 by the mouse pointer M1 is determined by the control unit 16. The process proceeds to step S65 if the shift to another screen Pg1 to Pg3, Pg5 is not specified. The process proceeds to step S21 of FIG. 20 if the shift to another screen Pg1 to Pg3, Pg5 is specified.

In step S65, whether or not to return to the TOP screen Tp1 is determined by the control unit 16. The process proceeds to step S66 if the button Tb1 on the data inquiry screen Pg4 is not pushed with the mouse pointer M1. The process returns to step S3 of FIG. 18 if the button Tb1 is pushed with the mouse pointer M1.

In step S66, whether or not the logoff is carried out at the terminal device 50 is determined by the control unit 16. If the button Lo1 on the data inquiry screen Pg4 is pushed with the mouse pointer M1, the login state is cancelled and the process returns to step S3 of FIG. 18. If the button Lo1 is not pushed with the mouse pointer M1, the process proceeds to step S67.

In step S67, whether or not the access from the terminal device 50 to the DC server 10 is terminated is determined by the control unit 16, similar to step S10 of FIG. 18. The process proceeds to step S68 if the access from the terminal device 50 to the DC server 10 is not terminated. The process returns to step S2 of FIG. 18 if the access from the terminal device 50 to the DC server 10 is terminated.

In step S68, whether or not the text link TL41 on the data inquiry screen Pg4 is specified by the mouse pointer M1 is determined by the control unit 16. The process proceeds to step S69 if the text link TL41 is specified by the mouse pointer M1. The process proceeds to step S70 if the text link TL41 is not specified by the mouse pointer M1.

In step S69, the data of measurement and medical checkup related to the one user are changed from the table format to the graph format on the data inquiry screen Pg4 by the output control portion 165 of the control unit 16 and the display control portion 261 of the control unit 26. In this case, the text link TL41 is switched to a text link (also referred to as table format link) “view with table” for changing from the graph format to the table format.

In step S70, whether or not the table format link on the data inquiry screen Pg4 is specified is determined by the control unit 16. The process returns to step S63 if the table format link is not specified by the mouse pointer M1. The process returns to step S62 if the table format link is specified by the mouse pointer M1.

In step S71 of FIG. 24, information (also referred to as notice information) indicating a notice from the doctor related to the one user is acquired by the control unit 16. The notice information related to the one user may be acquired from the PHR 141.

In step S72, the notice screen Pg5 (FIG. 17) is displayed on the display unit 22 of the terminal device 50 by the output control portion 165 of the control unit 16 and the display control portion 261 of the control unit 26. In the notice screen Pg5, the notice information related to the one user acquired in step S71 is visually output.

In step S73, various inputs on the notice screen Pg5 are accepted by the control unit 16.

In step S74, whether or not the text link TL51 on the notice screen Pg5 is specified by the mouse pointer M1 is determined by the control unit 16. The process proceeds to step S75 if the text link TL51 is specified by the mouse pointer M1. The process proceeds to step S78 if the text link TL51 is not specified by the mouse pointer M1.

In step S75, the appointment screen is displayed on the display unit 22 of the terminal device 50 by the output control portion 165 of the control unit 16 and the display control portion 261 of the control unit 26.

In step S76, various inputs on the appointment screen are accepted by the control unit 16. The one user can make an appointment for consultation at the medical institution, confirm the appointment, and the like on the appointment screen.

In step S77, whether or not an end button on the appointment screen is pushed with the mouse pointer M1 is determined by the control unit 16. The process proceeds to step S78 if the end button is pushed with the mouse pointer M1. The process returns to step S76 if the end button is not pushed with the mouse pointer M1.

In step S78, whether or not the shift to another screen Pg1 to Pg4 is specified by the specification of one of the buttons B1 to B4 on the notice screen Pg5 by the mouse pointer M1 is determined by the control unit 16. The process proceeds to step S79 if the shift to another screen Pg1 to Pg4 is not specified. The process proceeds to step S21 of FIG. 20 if the shift to another screen Pg1 to Pg4 is specified.

In step S79, whether or not to return to the TOP screen Tp1 is determined by the control unit 16. The process proceeds to step S80 if the button Tb1 on the notice screen Pg5 is not pushed with the mouse pointer M1. The process returns to step S3 of FIG. 18 if the button Tb1 is pushed with the mouse pointer M1.

In step S80, whether or not the logoff is carried out at the terminal device 50 is determined by the control unit 16. If the button Lo1 on the notice screen Pg5 is pushed with the mouse pointer M1, the login state is cancelled, and the process returns to step S3 of FIG. 18. If the button Lo1 is not pushed with the mouse pointer M1, the process proceeds to step S81.

In step S81, whether or not the access from the terminal device 50 to the DC server 10 is terminated is determined by the control unit 16, similar to step S10 of FIG. 18. The process returns to step S73 if the access from the terminal device 50 to the DC server 10 is not terminated. The process returns to step S2 of FIG. 18 if the access from the terminal device 50 to the DC server 10 is terminated.

In step S91 of FIG. 25, the search screen Pr1 (FIG. 12) is displayed on the display unit 22 of the terminal device 50 by the output control portion 165 of the control unit 16 and the display control portion 261 of the control unit 26.

In step S92, various inputs on the search screen Pr1 are accepted by the control unit 16. For example, various specifications, and the like related to the input of the search conditions by the mouse pointer M1 are accepted herein.

In step S93, whether or not the search condition is input is determined by the control unit 16. The process proceeds to step S94 if the search condition is input. The process proceeds to step S96 if the search condition is not input.

In step S94, the search for the medical institution corresponding to the search condition is carried out by the control unit 16. For example, information (also referred to as medical institution information) of a plurality of medical institutions is accumulated in the storage unit 14, and the medical institution that matches the search condition may be searched from the medical institution information.

In step S95, the search result in step S94 is visually output at the display unit 22 of the terminal device 50 by the output control portion 165 of the control unit 16 and the display control portion 261 of the control unit 26. In this case, a button (also referred to as re-search button) Rb1 for redoing the search is displayed with the search result on the search screen Pr1.

In step S96, whether or not the shift to another screen Pg1 to Pg5 is specified by the specification of one of the buttons B1 to B5 on the search screen Pr1 by the mouse pointer M1 is determined by the control unit 16. The process proceeds to step S97 if the shift to another screen Pg1 to Pg5 is not specified. The process proceeds to step S21 of FIG. 20 if the shift to another screen Pg1 to Pg5 is specified.

In step S97, whether or not to return to the TOP screen Tp1 is determined by the control unit 16. The process proceeds to step S98 if the button Tb1 on the search screen Pr1 is not pushed with the mouse pointer M1. The process returns to step S3 of FIG. 18 if the button Tb1 is pushed with the mouse pointer M1.

In step S98, whether or not the access from the terminal device 50 to the DC server 10 is terminated is determined by the control unit 16, similar to step S10 of FIG. 18. The process proceeds to step S99 if the access from the terminal device 50 to the DC server 10 is not terminated. The process returns to step S2 of FIG. 18 if the access from the terminal device 50 to the DC server 10 is terminated.

In step S99, whether or not the button Rb1 for redoing the search on the search screen Pr1 is pushed with the mouse pointer M1 is determined by the control unit 16. The process returns to step S91 if the button Rb1 is pushed with the mouse pointer M1. The process returns to step S96 if the button Bb1 is not pushed with the mouse pointer M1.

### (1-5) Conclusion

As described above, in the health support system 1 according to one preferred embodiment, the numerical value related to the state of one user for each numerical value item and the element related to the one user for each different item different from the numerical value item are acquired. The element indicating the range to which the numerical value related to the state of the one user belongs is recognized for each numerical value item by referencing the range reference information 142b. Furthermore, the health information corresponding to the combination of the element indicating one or more range for one or more numerical value items related to the one user and one or more element related to the one user for one or more different items is detected by referencing the detection reference information 142a. The detected health information is visually output. The health information that corresponds with the wide range of situations of the one user including the numerical data, and the like thus can be presented without any omission. In other words, the health information that corresponds with the detailed situation of the user can be presented.

The element related to the state of the user can be acquired based on the selection of the option and the input of the numerical value. Specifically, for example, the element related to the state of the user obtained through various different methods such as selection of option by the user in the medical interview, and the like, input of the measurement value by the user himself/herself, input of the numerical value serving as the examination result in the medical institution, input from the electronic medical chart, and the like can be acquired. Thus, the health information that corresponds with the detailed situation from various standpoints of the user can be presented.

For example, a configuration in which the element combination information accumulated in the detection reference information 142a includes the element combination information indicating the combination of elements over some items of all the items, and in which the health information is associated with the element combination information may be adopted. According to such configuration, the drawback in that the health information cannot be obtained due to lack of information is less likely to occur even if there is an item in which the reply is not input with respect to the medical interview, and even if the numerical value related to the numerical value item is not obtained because the examination and the measurement are not performed, for example.

### (2) Variant

The present invention is not limited to the one preferred embodiment described above, and various changes, modifications, and the like can be made within a scope not deviating from the gist of the invention.

For example, in the one preferred embodiment described above, the main configuration related to the health support function in the health support system 1 is realized by the DC server 10 and the terminal devices 40, 50, as shown in FIG. 4, but this is not the sole case. For example, the configuration of at least a part of the main configuration related to the health support function may be realized with the DC server 10, and the configuration of another part may be realized with the terminal devices 40, 50. Furthermore, for example, the configuration of a part of the main configuration related to the health support function may be realized with another information device. Moreover, for example, the main configuration related to the health support function may be realized in one information processing device. In this case, for example, the main configuration related to the health support function may be realized in the information processing device installed in the medical institution. If the health information is visually output in the information device owned by the user such as the terminal device 40, 50, the user can obtain the health information that corresponds with the detailed situation irrespective of the spatial and temporal restriction.

In the one preferred embodiment described above, the element indicating the health information is associated with the element combination information in the detection reference information 142a, and the substantive content corresponding to the element indicating the health information is stored in another text information 143, but this is not the sole case. For example, the substantive content of the health information may be directly associated with the element combination information in the detection reference information 142a.

It should be noted that all parts or one part configuring the one preferred embodiment described above and the various variants may be appropriately combined within a non-conflicting scope.

While the invention has been shown and described in detail, the foregoing description is in all aspects illustrative and not restrictive. It is therefore understood that numerous modifications and variations can be devised without departing from the scope of the invention.

What is claimed is:

1. A health support system comprising:
a storage unit configured to store first reference information, said first reference information being information in which a plurality of pieces of combination information is accumulated and in which health information is associated with respect to each said combination information, each said combination information being information indicating a combination of two or more elements over two or more items of a plurality of items related to a state of a person, one or more elements belonging to each item of said plurality of items in each said combination information;
an acquiring portion configured to acquire a numerical value related to a state of one user for each item of one or more numerical value items of said plurality of items, and acquire an element related to said one user for each item of one or more different items different from said one or more numerical value items of said plurality of items;
a range recognizing portion configured to recognize an element indicating a range to which said numerical value acquired by said acquiring portion belongs for each item of said one or more numerical value items by referencing second reference information in which a plurality of elements indicating a plurality of ranges belong to each item of said one or more numerical value items;
a detecting portion configured to detect said health information corresponding to a combination of one or more elements acquired for said one or more different items by said acquiring portion and one or more elements indicating one or more ranges recognized for said one or more numerical value items by said range recognizing portion by referencing said first reference information; and
an output unit configured to visually output said health information detected by said detecting portion.

2. The health support system according to claim 1, wherein
said health support system includes,
a server, and
a terminal device connected to said server in a data transmittable/receivable manner;
said server includes said storage unit, said acquiring portion, said range recognizing portion, and said detecting portion; and
said terminal device includes said output unit.

3. The health support system according to claim 1, wherein said plurality of pieces of combination information includes information indicating a combination of two or more elements over some items of said plurality of items.

4. The health support system according to claim 1, wherein said health support system further includes a difference amount recognizing portion configured to recognize a difference amount between elements of a first time point and a second time point later than said first time point for two or more elements of one or more elements acquired for said one or more different items by said acquiring portion and one or more elements indicating one or more ranges recognized for said one or more numerical value items by said range recognizing portion with respect to at least two items contained in said one or more different items and said one or more numerical value items;
said first reference information includes information in which said health information is associated with respect to a combination of difference amounts for two or more elements over said one or more different items and said one or more numerical value items; and
said detecting portion detects said health information corresponding to a combination of difference amounts for said two or more elements related to said at least two items recognized by said difference amount recognizing portion by referencing said first reference information.

5. The health support system according to claim 4, wherein said health support system further comprises:
an accumulation control portion configured to generate time-dependent change information by associating one combination of one or more elements acquired for said one or more different items by said acquiring portion and one or more elements indicating one or more ranges recognized for said one or more numerical value items by said range recognizing portion, with a combination of difference amounts for said two or more elements related to said one combination, and accumulate said time-dependent change information in said storage unit;
a deriving portion configured to derive statistical information related to a combination of difference amounts for said two or more elements with respect to a combination of one or more elements for said one or more different items and one or more elements indicating one or more ranges for said one or more numerical value items from said time-dependent change information accumulated in said storage unit; and
an adding portion configured to add information based on said statistical information to said health information detected by said detecting portion.

6. The health support system according to claim 4, wherein said health support system includes,
an accumulation control portion configured to generate time-dependent change information by associating one combination of one or more elements acquired for said one or more different items by said acquiring portion and one or more elements indicating one or more ranges recognized for said one or more numerical value items by said range recognizing portion, with a combination of difference amounts for said two or more elements related to said one combination, and accumulate said time-dependent change information in said storage unit;
a statistical information deriving portion configured to derive statistical information related to a combination of difference amounts for said two or more elements with respect to a combination of one or more elements acquired for said one or more different items by said acquiring portion and one or more elements indicating one or more ranges recognized for said one or more numerical value items by said range recognizing portion from said time-dependent change information accumulated in said storage unit; and
a determining portion configured to determine whether or not a relationship between first statistical information, which is related to a combination of difference amounts for said two or more elements derived from said time-dependent change information by said statistical information deriving portion at a first timing, and second statistical information, which is related to a combination of difference amounts for said two or more elements derived from said time-dependent change information by said statistical information deriving portion at a second timing later than said first timing satisfies a relationship set in advance; and
an annunciation control portion configured to cause an annunciation unit set in advance to make an annunciation corresponding to a determination result by said determining portion.

7. The health support system according to claim 1, further comprising:
a receiving portion configured to receive a signal from a device that satisfies a condition set in advice; and
an appending portion configured to append appending information corresponding to said signal received by said receiving portion with respect to said health information detected by said detecting portion; wherein
said output unit visually outputs said health information appended with said appending information by said appending portion.

8. The health support system according to claim 7, wherein
said storage unit stores said appending information; and
said appending portion appends said additional information stored in said storage unit with respect to said health information detected by said detecting portion each time said health information is detected by said detecting portion.

9. The health support system according to claim 6, further comprising:
a receiving portion configured to receive a signal from a device that satisfies a condition set in advice; and
an updating portion configured to update said health information contained in said first reference information according to said signal received by said receiving portion.

10. The health support system according to claim 1, wherein said acquiring portion acquires a numerical value related to a state of said one user for each said numerical value item from information indicating a result of at least one of measurement and examination related to a state of said one user.

11. The health support system according to claim 1, wherein said acquiring portion acquires an element related to said one user according to a selection result of one option from a plurality of options for each said different item.

12. A health support method in a health support system including a storage unit configured to store information, a control unit including a processor and configured to perform information processing, and an output unit configured to visually output information, the health support method comprising the steps of:
(a) storing first reference information by said storage unit, said first reference information being information in which a plurality of pieces of combination information is accumulated and in which health information is associated with respect to each said combination information, each said combination information being information indicating a combination of two or more elements over two or more items of a plurality of items related to a state of a person, one or more elements belonging to each item of said plurality of items in each said combination information;
(b) acquiring a numerical value related to a state of one user for each item of one or more numerical value items of said plurality of items, and acquiring an element related to said one user for each item of one or more different items different from said one or more numerical value items of said plurality of items by an acquiring portion of said control unit;
(c) recognizing an element indicating a range to which said numerical value acquired in said step (b) belongs for each item of said one or more numerical value items by referencing second reference information in which a plurality of elements indicating a plurality of ranges belong to each item of said one or more numerical value items by a recognizing portion of said control unit;
(d) detecting said health information corresponding to a combination of one or more elements acquired for said one or more different items in said step (b) and one or more elements indicating one or more ranges recognized for said one or more numerical value items in said step (c) by referencing said first reference information by a detecting portion of said control unit; and
(e) visually outputting said health information detected in said step (d) by said output unit.

13. A non-transitory computer readable recording medium storing a computer-readable program, the program controlling a health support system to operate as one health support system, and the one health support system comprising:
a storage unit configured to store first reference information, said first reference information being information in which a plurality of pieces of combination information is accumulated and in which health information is associated with respect to each said combination information, each said combination information being information indicating a combination of two or more elements over two or more items of a plurality of items related to a state of a person, one or more elements belonging to each item of said plurality of items in each said combination information;
an acquiring portion configured to acquire a numerical value related to a state of one user for each item of one or more numerical value items of said plurality of items, and acquire an element related to said one user for each item of one or more different items different from said one or more numerical value items of said plurality of items;
a range recognizing portion configured to recognize an element indicating a range to which said numerical value acquired by said acquiring portion belongs for each item of said one or more numerical value items by referencing second reference information in which a plurality of elements indicating a plurality of ranges belong to each item of said one or more numerical value items;
a detecting portion configured to detect said health information corresponding to a combination of one or more elements acquired for said one or more different items by said acquiring portion and one or more elements indicating one or more ranges recognized for said one or more numerical value items by said range recognizing portion by referencing said first reference information; and
an output unit configured to visually output said health information detected by said detecting portion.
